(19) United States
(12) Patent Application Publication
(10) Pub. No.: US 2025/0212220 A1
(43) Pub. Date: Jun. 26, 2025

(54) DISCONTINUOUS RECEPTION AND SEARCH SPACE FEATURES

(71) Applicant: QUALCOMM Incorporated, San Diego, CA (US)

(72) Inventors: Le LIU, San Jose, CA (US); Gabi SARKIS, San Diego, CA (US); Weimin DUAN, San Diego, CA (US); Kangqi LIU, San Diego, CA (US)

(21) Appl. No.: 18/391,391

(22) Filed: Dec. 20, 2023

(51) Int. Cl. H04W 72/23; H04L 5/00

(52) U.S. Cl. CPC H04W 72/23; H04L 5/0082

(57) ABSTRACT

Various aspects of the present disclosure generally relate to wireless communication. In some aspects, a user equipment (UE) may receive a configuration of a duration or a duration timer, and of an inactivity timer of a first search space (SS) set or SS set group (SSSG). The UE may start the duration or the duration timer in each monitoring occasion of the first SS set or SSSG. The UE may receive, in a monitoring occasion of the first SS set or SSSG within the duration or before the duration timer expires, a physical downlink control channel (PDCCH) message indicating a new transmission in the first SS set or SSSG. The UE may start or restart the inactivity timer for the monitoring occasion of the first SS set or SSSG after an end of receiving the PDCCH message. The UE may monitor for PDCCH messages during the inactivity timer.

### FIELD OF THE DISCLOSURE

Aspects of the present disclosure generally relate to wireless communication and specifically relate to techniques, apparatuses, and methods for using discontinuous reception (DRX) and search space features.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving a configuration of a duration or a duration timer, and of an inactivity timer of a first search space (SS) set or SS set group (SSSG). The method may include starting the duration or the duration timer in each monitoring occasion of the first SS set or SSSG. The method may include receiving, in a monitoring occasion of the first SS set or SSSG within the duration or before the duration timer expires, a physical downlink control channel (PDCCH) message indicating a new transmission in the first SS set or SSSG. The method may include starting or restarting the inactivity timer for the monitoring occasion of the first SS set or SSSG after an end of receiving the PDCCH message. The method may include monitoring for PDCCH messages during the inactivity timer.

Some aspects described herein relate to a method of wireless communication performed by a UE. The method may include receiving a configuration of an inactivity timer, a long periodicity, a short periodicity, and a short periodicity timer of a first SS set or SSSG. The method may include starting or restarting, in a first symbol after an inactivity timer for the first SS set or SSSG expires, a short periodicity timer for on durations having a short periodicity that is shorter than a long periodicity used for the first SS set or SSSG. The method may include monitoring for PDCCH messages in the first SS set or SSSG during the on durations having the short periodicity. The method may include monitoring, after the short periodicity timer expires, for PDCCH messages in the first SS set or SSSG during on durations having the long periodicity.

Some aspects described herein relate to a method of wireless communication performed by a UE. The method may include receiving a configuration of a discontinuous reception (DRX) associated with at least one SS set or SSSG. The method may include starting a duration timer for DRX that is applied to each monitoring occasion of the at least one associated SS set or SSSG. The method may include receiving a PDCCH message indicating a new transmission in the at least one associated SS set or SSSG. The method may include starting an inactivity timer for DRX that is applied to the at least one associated SS set or SSSG upon expiration of the duration timer. The method may include performing PDCCH monitoring until the inactivity timer expires.

Some aspects described herein relate to a method of wireless communication performed by a UE. The method may include receiving multiple DRX configurations. The method may include operating in a first DRX mode in accordance with a first DRX configuration of the multiple DRX configurations. The method may include receiving a first indication to switch to a second DRX mode. The method may include operating in the second DRX mode in accordance with a second DRX configuration of the multiple DRX configurations.

Some aspects described herein relate to a method of wireless communication performed by a UE. The method may include receiving an indication of a control resource set (CORESET). The method may include operating in a DRX mode that applies to at least one SS set associated with the CORESET.

Some aspects described herein relate to an apparatus for wireless communication at a UE. The apparatus may include one or more memories and one or more processors coupled to the one or more memories. The one or more processors may be individually or collectively configured to receive a configuration of a duration or a duration timer, and of an inactivity timer of a first SS set or SSSG. The one or more processors may be individually or collectively configured to start the duration or the duration timer in each monitoring occasion of the first SS set or SSSG. The one or more processors may be individually or collectively configured to receive, in a monitoring occasion of the first SS set or SSSG within the duration or before the duration timer expires, a PDCCH message indicating a new transmission in the first SS set or SSSG. The one or more processors may be individually or collectively configured to start or restart the inactivity timer for the monitoring occasion of the first SS set or SSSG after an end of receiving the PDCCH message. The one or more processors may be individually or collectively configured to monitor for PDCCH messages during the inactivity timer.

Some aspects described herein relate to an apparatus for wireless communication at a UE. The apparatus may include one or more memories and one or more processors coupled to the one or more memories. The one or more processors may be individually or collectively configured to receive a configuration of an inactivity timer, a long periodicity, a short periodicity, and a short periodicity timer of a first SS set or SSSG. The one or more processors may be individually or collectively configured to start or restart, in a first symbol after an inactivity timer for the first SS set or SSSG expires, a short periodicity timer for on durations having a short periodicity that is shorter than a long periodicity used for the first SS set or SSSG. The one or more processors may be individually or collectively configured to monitor for PDCCH messages in the first SS set or SSSG during the on durations having the short periodicity. The one or more processors may be individually or collectively configured to monitor, after the short periodicity timer expires, for PDCCH messages in the first SS set or SSSG during on durations having the long periodicity.

Some aspects described herein relate to an apparatus for wireless communication at a UE. The apparatus may include one or more memories and one or more processors coupled to the one or more memories. The one or more processors may be individually or collectively configured to receive a configuration of a DRX associated with at least one SS set or SSSG. The one or more processors may be individually or collectively configured to start a duration timer for DRX that is applied to each monitoring occasion of the at least one associated SS set or SSSG. The one or more processors may be individually or collectively configured to receive a PDCCH message indicating a new transmission in the at least one associated SS set or SSSG. The one or more processors may be individually or collectively configured to start an inactivity timer for DRX that is applied to the at least one associated SS set or SSSG upon expiration of the duration timer. The one or more processors may be individually or collectively configured to perform PDCCH monitoring until the inactivity timer expires.

Some aspects described herein relate to an apparatus for wireless communication at a UE. The apparatus may include one or more memories and one or more processors coupled to the one or more memories. The one or more processors may be individually or collectively configured to receive multiple DRX configurations. The one or more processors may be individually or collectively configured to operate in a first DRX mode in accordance with a first DRX configuration of the multiple DRX configurations. The one or more processors may be individually or collectively configured to receive a first indication to switch to a second DRX mode. The one or more processors may be individually or collectively configured to operate in the second DRX mode in accordance with a second DRX configuration of the multiple DRX configurations.

Some aspects described herein relate to an apparatus for wireless communication at a UE. The apparatus may include one or more memories and one or more processors coupled to the one or more memories. The one or more processors May be individually or collectively configured to receive an indication of a CORESET. The one or more processors may be individually or collectively configured to operate in a DRX mode that applies to at least one SS set associated with the CORESET.

Some aspects described herein relate to a non-transitory computer-readable medium that stores a set of instructions for wireless communication by a UE. The set of instructions, when executed by one or more processors of the UE, may cause the UE to receive a configuration of a duration or a duration timer, and of an inactivity timer of a first SS set or SSSG. The set of instructions, when executed by one or more processors of the UE, may cause the UE to start the duration or the duration timer in each monitoring occasion of the first SS set or SSSG. The set of instructions, when executed by one or more processors of the UE, may cause the UE to receive, in a monitoring occasion of the first SS set or SSSG within the duration or before the duration timer expires, a PDCCH message indicating a new transmission in the first SS set or SSSG. The set of instructions, when executed by one or more processors of the UE, may cause the UE to start or restart the inactivity timer for the monitoring occasion of the first SS set or SSSG after an end of receiving the PDCCH message. The set of instructions, when executed by one or more processors of the UE, may cause the UE to monitor for PDCCH messages during the inactivity timer.

Some aspects described herein relate to a non-transitory computer-readable medium that stores a set of instructions for wireless communication by a UE. The set of instructions, when executed by one or more processors of the UE, may cause the UE to receive a configuration of an inactivity timer, a long periodicity, a short periodicity, and a short periodicity timer of a first SS set or SSSG. The set of instructions, when executed by one or more processors of the UE, may cause the UE to start or restart, in a first symbol after an inactivity timer for the first SS set or SSSG expires, a short periodicity timer for on durations having a short periodicity that is shorter than a long periodicity used for the first SS set or SSSG. The set of instructions, when executed by one or more processors of the UE, may cause the UE to monitor for PDCCH messages in the first SS set or SSSG during the on durations having the short periodicity. The set of instructions, when executed by one or more processors of the UE, may cause the UE to monitor, after the short periodicity timer expires, for PDCCH messages in the first SS set or SSSG during on durations having the long periodicity.

Some aspects described herein relate to a non-transitory computer-readable medium that stores a set of instructions for wireless communication by a UE. The set of instructions, when executed by one or more processors of the UE, may cause the UE to receive a configuration of a DRX associated with at least one SS set or SSSG. The set of instructions, when executed by one or more processors of the UE, may cause the UE to start a duration timer for DRX that is applied to each monitoring occasion of the at least one associated SS set or SSSG. The set of instructions, when executed by one or more processors of the UE, may cause the UE to receive a PDCCH message indicating a new transmission in the at least one associated SS set or SSSG. The set of instructions, when executed by one or more processors of the UE, may cause the UE to start an inactivity timer for DRX that is applied to the at least one associated SS set or SSSG upon expiration of the duration timer. The set of instructions, when executed by one or more processors of the UE, may cause the UE to perform PDCCH monitoring until the inactivity timer expires.

Some aspects described herein relate to a non-transitory computer-readable medium that stores a set of instructions for wireless communication by a UE. The set of instructions, when executed by one or more processors of the UE, may cause the UE to receive multiple DRX configurations. The set of instructions, when executed by one or more processors of the UE, may cause the UE to operate in a first DRX mode in accordance with a first DRX configuration of the multiple DRX configurations. The set of instructions, when executed by one or more processors of the UE, may cause the UE to receive a first indication to switch to a second DRX mode. The set of instructions, when executed by one or more processors of the UE, may cause the UE to operate in the second DRX mode in accordance with a second DRX configuration of the multiple DRX configurations.

Some aspects described herein relate to a non-transitory computer-readable medium that stores a set of instructions for wireless communication by a UE. The set of instructions, when executed by one or more processors of the UE, may cause the UE to receive an indication of a CORESET. The set of instructions, when executed by one or more processors of the UE, may cause the UE to operate in a DRX mode that applies to at least one SS set associated with the CORESET.

Some aspects described herein relate to an apparatus for wireless communication. The apparatus may include means for receiving a configuration of a duration or a duration timer, and of an inactivity timer of a first SS set or SSSG. The apparatus may include means for starting the duration or the duration timer in each monitoring occasion of the first SS set or SSSG. The apparatus may include means for receiving, in a monitoring occasion of the first SS set or SSSG within the duration or before the duration timer expires, a PDCCH message indicating a new transmission in the first SS set or SSSG. The apparatus may include means for starting or restarting the inactivity timer for the monitoring occasion of the first SS set or SSSG after an end of receiving the PDCCH message. The apparatus may include means for monitoring for PDCCH messages during the inactivity timer.

Some aspects described herein relate to an apparatus for wireless communication. The apparatus may include means for receiving a configuration of an inactivity timer, a long periodicity, a short periodicity, and a short periodicity timer of a first SS set or SSSG. The apparatus may include means for starting or restarting, in a first symbol after an inactivity timer for the first SS set or SSSG expires, a short periodicity timer for on durations having a short periodicity that is shorter than a long periodicity used for the first SS set or SSSG. The apparatus may include means for monitoring for PDCCH messages in the first SS set or SSSG during the on durations having the short periodicity. The apparatus may include means for monitoring, after the short periodicity timer expires, for PDCCH messages in the first SS set or SSSG during on durations having the long periodicity.

Some aspects described herein relate to an apparatus for wireless communication. The apparatus may include means for receiving a configuration of a DRX associated with at least one SS set or SSSG. The apparatus may include means for starting a duration timer for DRX that is applied to each monitoring occasion of the at least one associated SS set or SSSG. The apparatus may include means for receiving a PDCCH message indicating a new transmission in the at least one associated SS set or SSSG. The apparatus may include means for starting an inactivity timer for DRX that is applied to the at least one associated SS set or SSSG upon expiration of the duration timer. The apparatus may include means for performing PDCCH monitoring until the inactivity timer expires.

Some aspects described herein relate to an apparatus for wireless communication. The apparatus may include means for receiving multiple DRX configurations. The apparatus may include means for operating in a first DRX mode in accordance with a first DRX configuration of the multiple DRX configurations. The apparatus may include means for receiving a first indication to switch to a second DRX mode. The apparatus may include means for operating in the second DRX mode in accordance with a second DRX configuration of the multiple DRX configurations.

Some aspects described herein relate to an apparatus for wireless communication. The apparatus may include means for receiving an indication of a CORESET. The apparatus may include means for operating in a DRX mode that applies to at least one SS set associated with the CORESET.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of discontinuous reception (DRX), in accordance with the present disclosure.

FIG. 5 is a diagram illustrating an example resource structure for wireless communication, in accordance with the present disclosure.

FIG. 6 is a diagram illustrating an example of using both search space (SS) and DRX features, in accordance with the present disclosure.

FIG. 7 is a diagram illustrating an example associated with using both SS and DRX features, in accordance with the present disclosure.

FIG. 8 is a diagram illustrating an example of using SS and DRX features, in accordance with the present disclosure.

FIG. 9 is a diagram illustrating an example associated with using SS and DRX features, in accordance with the present disclosure.

FIG. 10 is a diagram illustrating an example associated with using SS and DRX features, in accordance with the present disclosure.

FIG. 11 is a diagram illustrating an example associated with using SS and DRX features, in accordance with the present disclosure.

FIG. 12 is a diagram illustrating an example associated with using SS and DRX features, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a UE or an apparatus of a UE, in accordance with the present disclosure.

FIG. 15 is a diagram illustrating an example process performed, for example, at a UE or an apparatus of a UE, in accordance with the present disclosure.

FIG. 16 is a diagram illustrating an example process performed, for example, at a UE or an apparatus of a UE, in accordance with the present disclosure.

FIG. 17 is a diagram illustrating an example process performed, for example, at a UE or an apparatus of a UE, in accordance with the present disclosure.

FIG. 18 is a diagram of an example apparatus for wireless communication, in accordance with the present disclosure.

FIG. 19 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure May be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may use a discontinuous reception (DRX) cycle to conserve power. Each DRX cycle includes an active period during which the UE uses power for reception and a non-active period during which the UE reduces its power consumption and does not receive signals (and does not transmit signals). The active period may also be referred to as an “active duration,” an “on duration,” or an “active time”. The non-active period may also be referred to as an “inactive time,” an “inactive period,” a “non-active duration,” an “inactive duration,” or a “non-active period.”

A search space (SS) may include all possible locations (e.g., in time and/or frequency) where a physical downlink control channel (PDCCH) message may be received. A control resource set (CORESET) may include one or more SSs, such as a UE-specific SS, a group-common SS, and/or a common SS. An SS may indicate a set of locations where a UE may find PDCCHs that can potentially be used to transmit control information to the UE.

Various aspects relate generally to wireless communications. Some aspects more specifically relate to adding DRX features to the use of SS sets for an enhanced SS configuration. For example, a network entity may configure a UE with an adaptive timer/periodicity SS like what is used for DRX. Alternatively, or additionally, in some aspects, SS features may be added to DRX for an enhanced DRX configuration. For example, the network entity may configure service-specific DRX with dynamic switching, which is used with SSs.

Particular aspects of the subject matter described in this disclosure can be implemented to realize one or more of the following potential advantages. In some examples, by combining SS and DRX features, signaling resources may be used more efficiently with DRX and power may be conserved with the use of SS sets.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

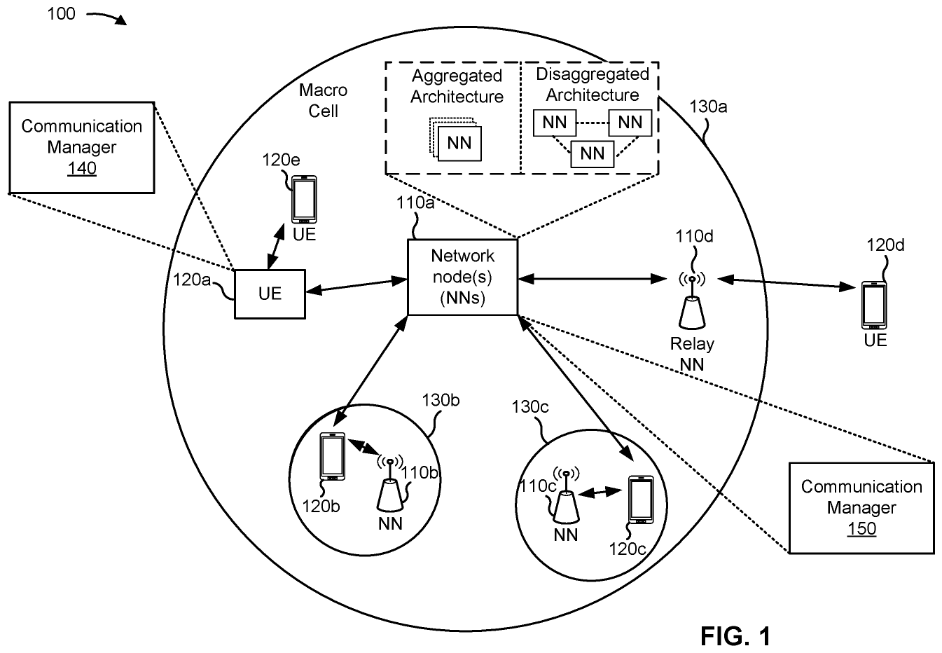

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmit receive point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NCJT).

In some aspects, a UE (e.g., a UE 120) may include a communication manager 140. As described in more detail elsewhere herein, the communication manager 140 may receive a configuration of a duration or a duration timer, and of an inactivity timer of a first SS set or SS set group (SSSG); start the duration or the duration timer in each monitoring occasion of the first SS set or SSSG; receive, in a monitoring occasion of the first SS set or SSSG within the duration or before the duration timer expires, a PDCCH message indicating a new transmission in the first SS set or SSSG; start or restarting the inactivity timer for the monitoring occasion of the first SS set or SSSG after an end of receiving the PDCCH message; and monitor for PDCCH messages during the inactivity timer. Additionally, or alternatively, the communication manager 140 may perform one or more other operations described herein.

In some aspects, the communication manager 140 may receive a configuration of an inactivity timer, a long periodicity, a short periodicity, and a short periodicity timer of a first SS set or SSSG. The communication manager 140 may start or restart, in a first symbol after an inactivity timer for the first SS set or SSSG expires, a short periodicity timer for on durations having a short periodicity that is shorter than a long periodicity used for the first SS set or SSSG. The communication manager 140 may monitor for PDCCH messages in the first SS set or SSSG during the on durations having the short periodicity. The communication manager 140 may monitor, after the short periodicity timer expires, for PDCCH messages in the first SS set or SSSG during on durations having the long periodicity. Additionally, or alternatively, the communication manager 140 may perform one or more other operations described herein.

In some aspects, the communication manager 140 may receive a configuration of a DRX associated with at least one SS set or SSSG. The communication manager 140 may start a duration timer for DRX that is applied to each monitoring occasion of the at least one associated SS set or SSSG. The communication manager 140 may receive a PDCCH message indicating a new transmission in the at least one associated SS set or SSSG. The communication manager 140 may start an inactivity timer for DRX that is applied to the at least one associated SS set or SSSG upon expiration of the duration timer. The communication manager 140 may perform PDCCH monitoring until the inactivity timer expires.

In some aspects, the communication manager 140 may receive multiple DRX configurations. The communication manager 140 may operate in a first DRX mode in accordance with a first DRX configuration of the multiple DRX configurations. The communication manager 140 may receive a first indication to switch to a second DRX mode. The communication manager 140 may operate in the second DRX mode in accordance with a second DRX configuration of the multiple DRX configurations.

In some aspects, the communication manager 140 may receive an indication of a CORESET. The communication manager 140 may operate in a DRX mode that applies to at least one SS set associated with the CORESET. Additionally, or alternatively, the communication manager 140 may perform one or more other operations described herein.

As indicated above, FIG. 1 is provided as an example. Other examples may differ from what is described with regard to FIG. 1.

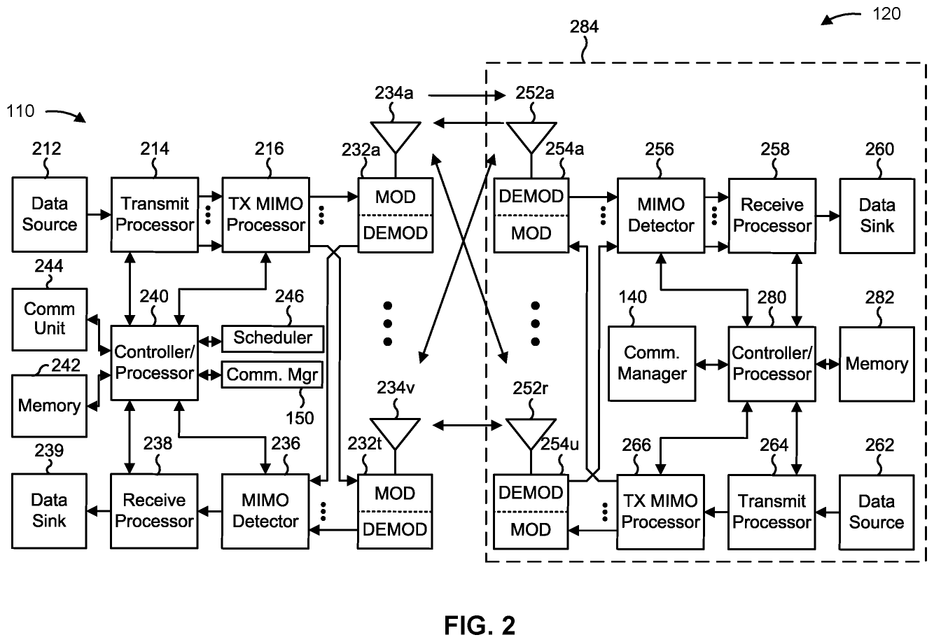

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

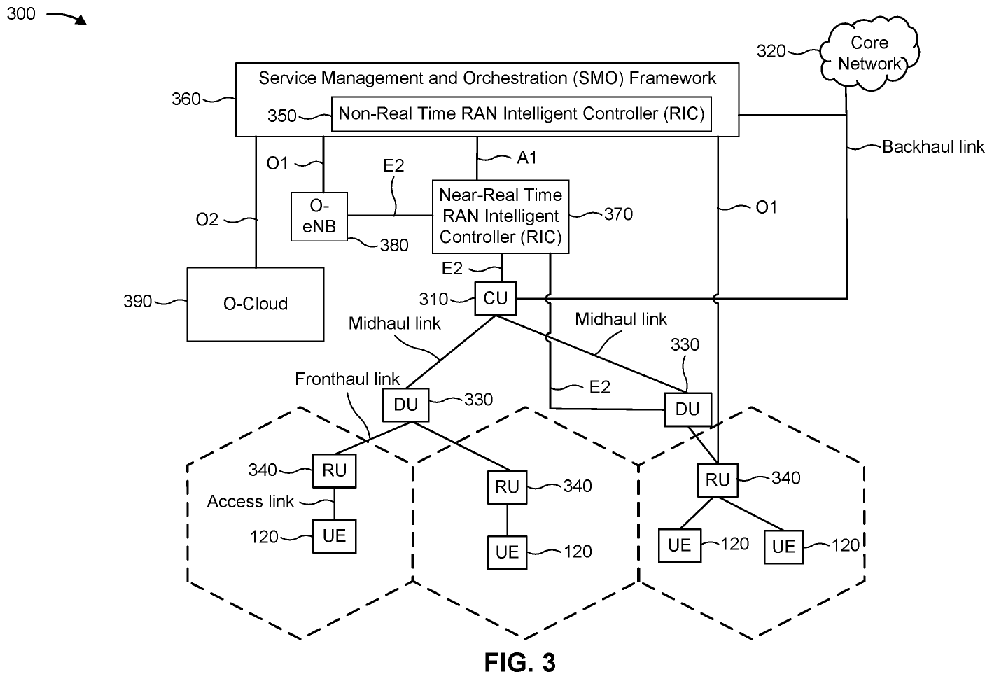

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

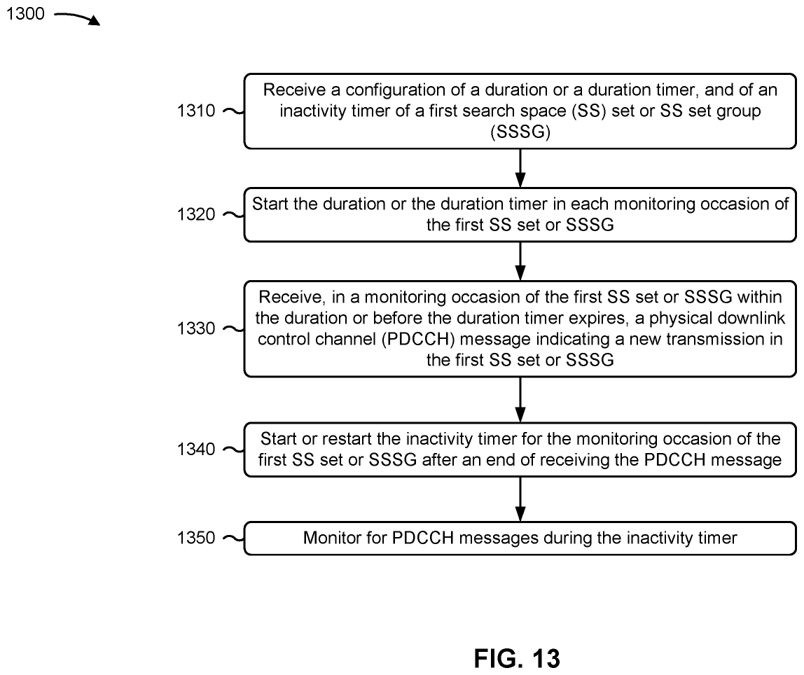

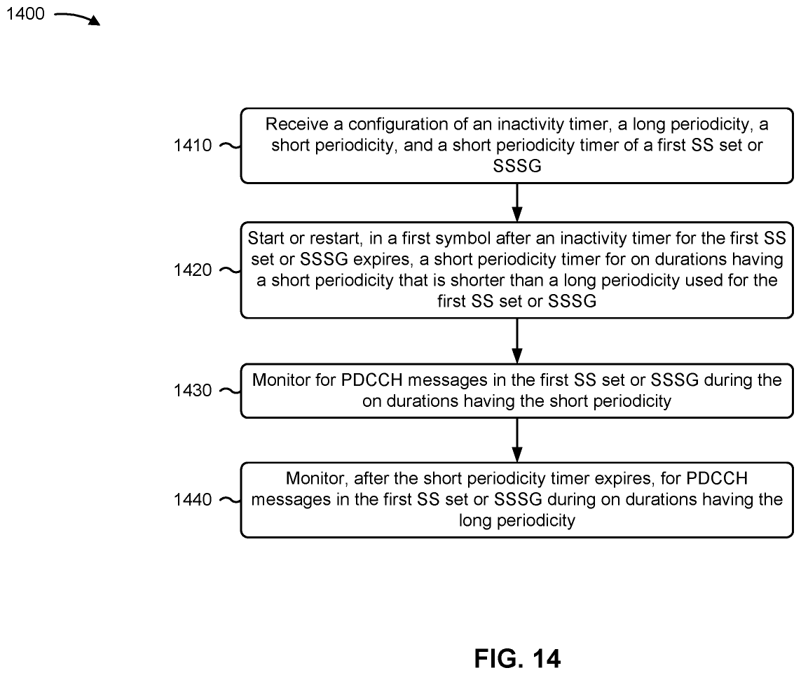

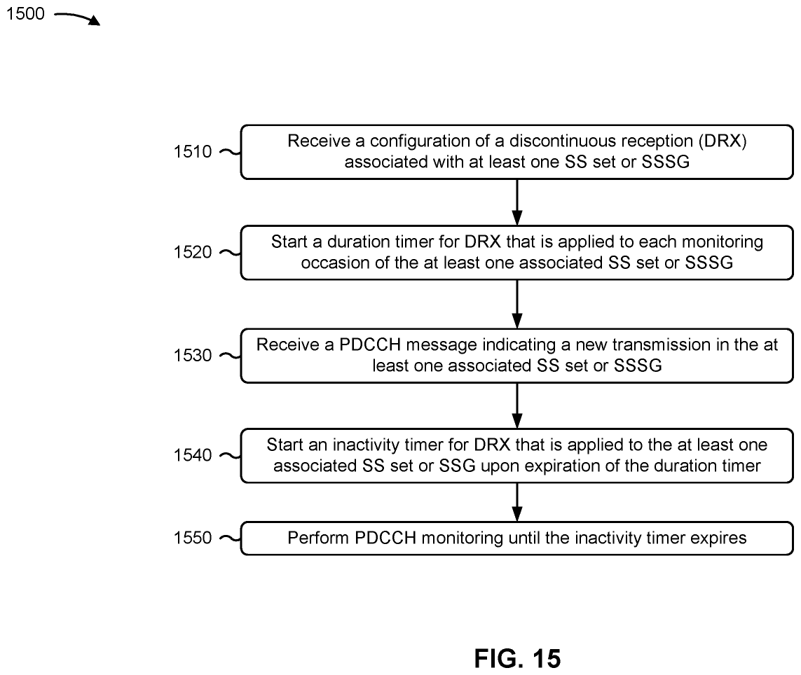

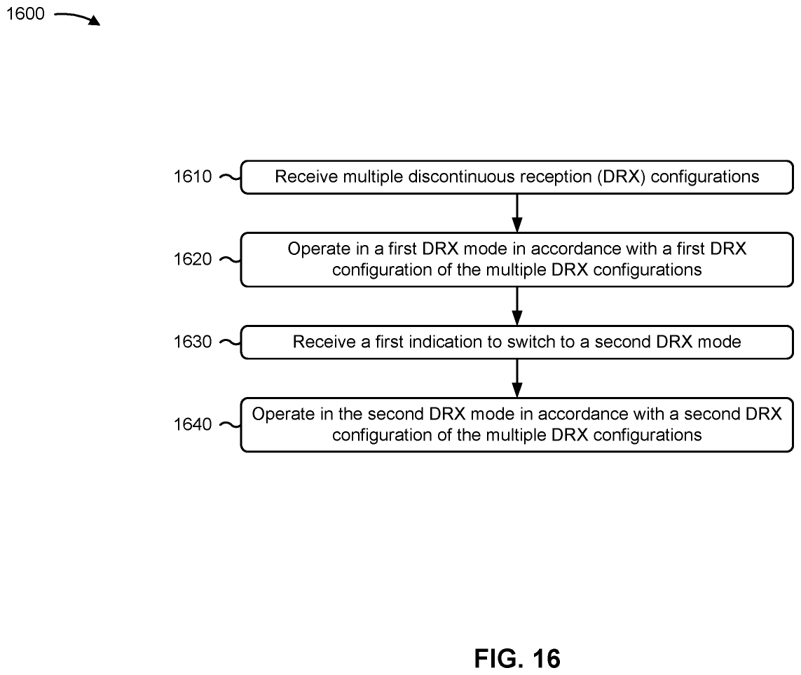

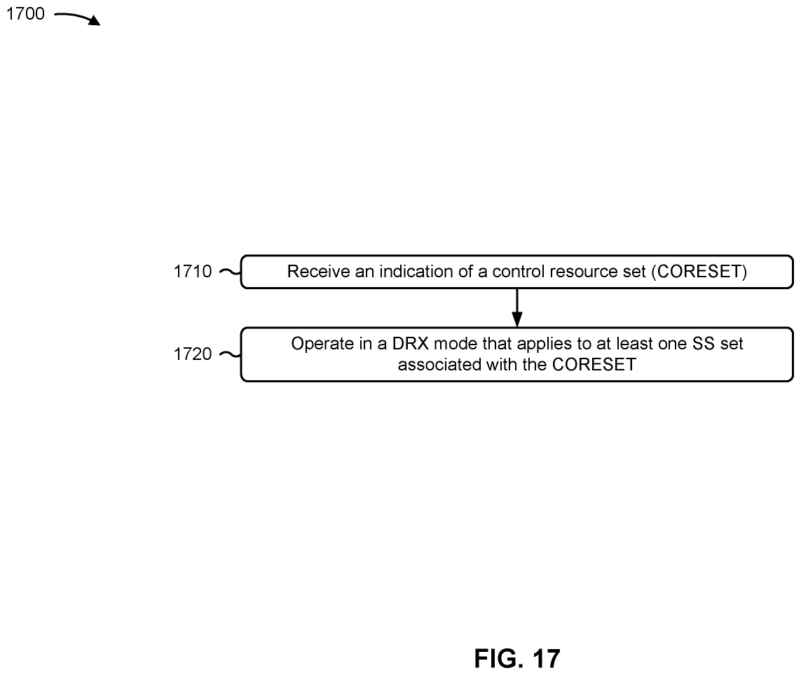

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with using SS and DRX features, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13, process 1400 of FIG. 14, process 1500 of FIG. 15, process 1600 of FIG. 16, process 1700 of FIG. 17, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, process 1500 of FIG. 15, process 1600 of FIG. 16, process 1700 of FIG. 17, or other processes as described herein. In some examples, executing instructions may include running the instructions, converting the instructions, compiling the instructions, and/or interpreting the instructions, among other examples.

In some aspects, a UE (e.g., a UE 120) includes means for receiving a configuration of a duration or a duration timer, and of an inactivity timer of a first SS set or SSSG; means for starting the duration or the duration timer in each monitoring occasion of the first SS set or SSSG; means for receiving, in a monitoring occasion of the first SS set or SSSG within the duration or before the duration timer expires, a PDCCH message indicating a new transmission in the first SS set or SSSG; means for starting or restarting the inactivity timer for the monitoring occasion of the first SS set or SSSG after an end of receiving the PDCCH message; and/or means for monitoring for PDCCH messages during the inactivity timer.

In some aspects, the UE includes means for receiving a configuration of an inactivity timer, a long periodicity, a short periodicity, and a short periodicity timer of a first SS set or SSSG; means for starting or restarting, in a first symbol after an inactivity timer for the first SS set or SSSG expires, a short periodicity timer for on durations having a short periodicity that is shorter than a long periodicity used for the first SS set or SSSG; means for monitoring for PDCCH messages in the first SS set or SSSG during the on durations having the short periodicity; and/or means for monitoring, after the short periodicity timer expires, for PDCCH messages in the first SS set or SSSG during on durations having the long periodicity.

In some aspects, the UE includes means for receiving a configuration of a DRX associated with at least one SS set or SSSG; means for starting a duration timer for DRX that is applied to each monitoring occasion of the at least one associated SS set or SSSG; means for receiving a PDCCH message indicating a new transmission in the at least one associated SS set or SSSG; means for starting an inactivity timer for DRX that is applied to the at least one associated SS set or SSSG upon expiration of the duration timer; and/or means for performing PDCCH monitoring until the inactivity timer expires.

In some aspects, the UE includes means for receiving multiple DRX configurations; means for operating in a first DRX mode in accordance with a first DRX configuration of the multiple DRX configurations; means for receiving a first indication to switch to a second DRX mode; and/or means for operating in the second DRX mode in accordance with a second DRX configuration of the multiple DRX configurations.

In some aspects, the UE includes means for receiving an indication of a CORESET; and/or means for operating in a DRX mode that applies to at least one SS set associated with the CORESET. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

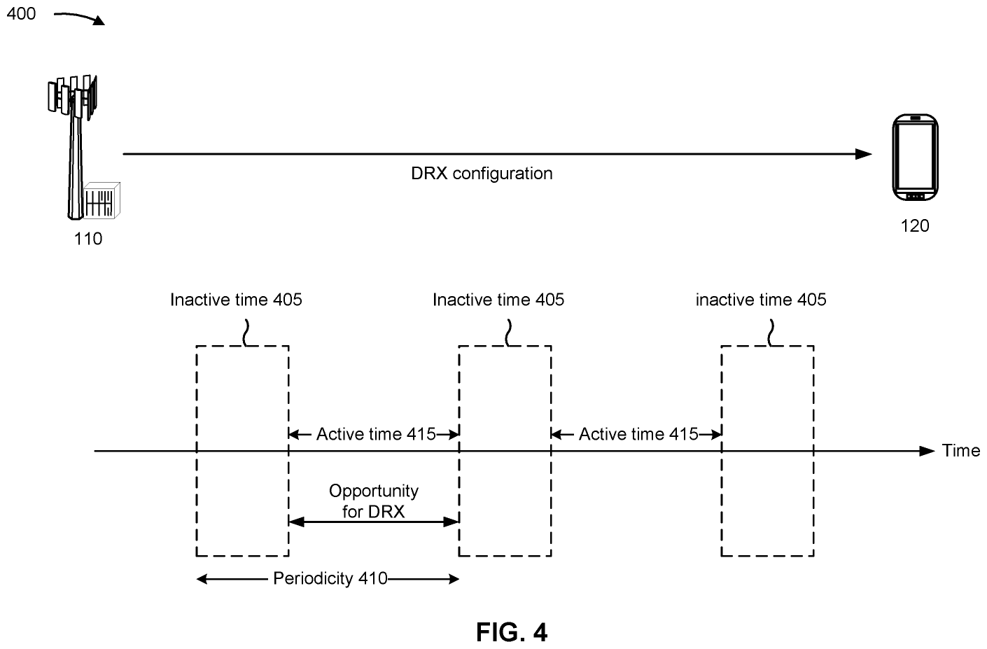

FIG. 4 is a diagram illustrating an example 400 of DRX, in accordance with the present disclosure. As shown in FIG. 4, example 400 includes a UE 120 in communication with a network node 110. In some examples, the UE 120 may be in a connected state (e.g., an RRC connected state) with the network node 110.

As shown, the network node 110 may transmit a DRX configuration to the UE 120 to configure a DRX cycle for the UE 120. Each DRX cycle includes an active period during which the UE uses power for reception and a non-active period during which the UE reduces its power consumption and does not receive signals (and does not transmit signals). The active period may also be referred to as an “active duration,” an “on duration,” or an “active time”. The non-active period may also be referred to as an “inactive time,” an “inactive period,” a “non-active duration,” an “inactive duration,” or a “non-active period.” Example 400 shows an inactive time 405 and an active time 415 of a DRX cycle. Example 400 also shows a periodicity 410 of a DRX cycle.

When the UE 120 is in an inactive time 405, the UE may enter a sleep state. Sleeping may involve turning off a radio and one or more other components or functions. Turning off or switching off a radio may include removing power from the radio such that the radio is not fully operating or operating with a lower power. The UE may wake up for an active time. Waking up may involve turning on a radio and one or more other components or functions. Turning on or switching on a radio may include increasing power to the radio such that the radio is fully operating or operating with full power. DRX may be used for PDCCH monitoring, where the UE turns off the PDCCH monitoring during periods of inactivity.

The DRX may be an enhanced DRX (eDRX), a connected DRX (cDRX), or an idle mode DRX (IDRX). The DRX may involve dual DRX groups for cell groups. Multicast and broadcast services (MBS) DRX may be configured per group radio network temporary identifier (G-RNTI). In some aspects, a wake up signal (WUS) may be received for DRX in a different UE mode for power saving. The WUS may be a sequence-based WUS for RRC_IDLE (enhanced MTC (eMTC) and narrow band (NB) IoT), a PDCCH-based WUS for RRC_CONN, a PDCCH-based permanent equipment identifier (PEI) for RRC_IDLE/INACTIVE paging, or a low-power WUS for RRC_IDLE/INACTIVE paging. A low-power WUS (or other WUSs) may be extended to RRC_CONN UEs.

A DRX configuration may indicate a DRX long cycle and a DRX start offset. The DRX configuration may indicate a DRX on a duration timer and a DRX inactivity timer. After the UE receives any downlink PDCCH message before expiry of the on duration timer, the UE may start an inactivity timer and extend the active time. A short DRX cycle may be used for bursty traffic. DRX short cycles may provide for more frequent on durations to handle bursty traffic before switching back to DRX long cycles. The DRX configuration may indicate a hybrid automatic repeat request (HARQ) timer or a DRX retransmission timer.

As indicated above, FIG. 4 is provided as an example. Other examples may differ from what is described with regard to FIG. 4.

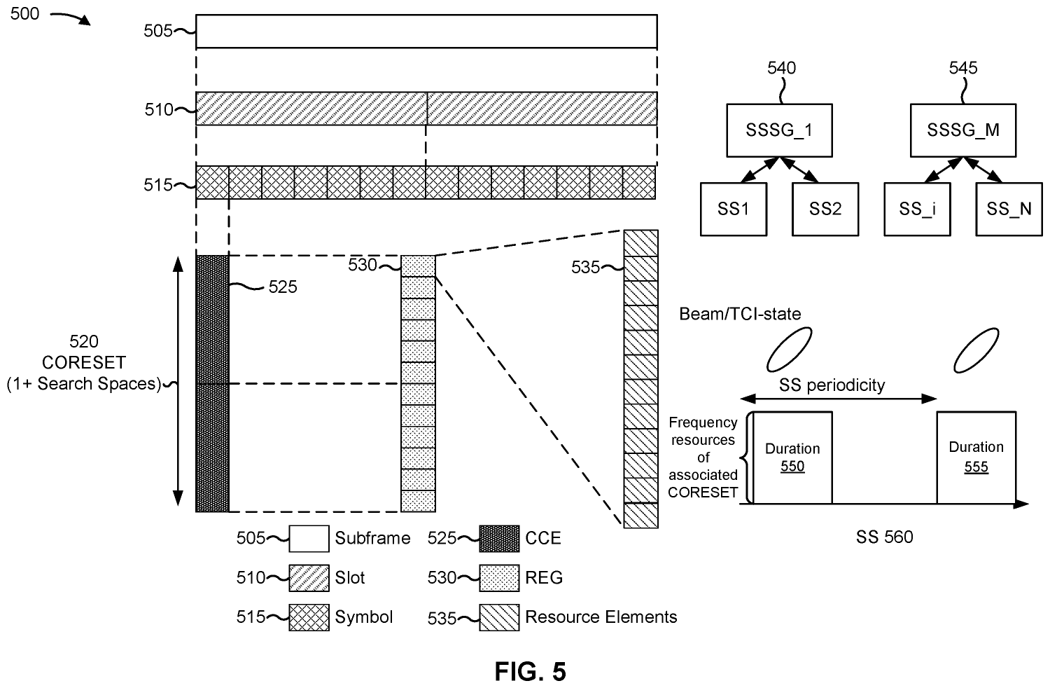

FIG. 5 is a diagram illustrating an example resource structure 500 for wireless communication, in accordance with the present disclosure. Resource structure 500 shows an example of various groups of resources described herein. As shown, resource structure 500 may include a subframe 505. Subframe 505 may include multiple slots 510. While resource structure 500 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 510 may include multiple symbols 515, such as 14 symbols per slot.

The potential control region of a slot 510 may be referred to as a CORESET 520 and may be structured to support an efficient use of resources, such as by flexible configuration or reconfiguration of resources of the CORESET 520 for one or more PDCCHs and/or one or more physical downlink shared channels (PDSCHs). In some aspects, the CORESET 520 may occupy the first symbol 515 of a slot 510, the first two symbols 515 of a slot 510, or the first three symbols 515 of a slot 510. Thus, a CORESET 520 may include multiple resource blocks (RBs) in the frequency domain, and either one, two, or three symbols 515 in the time domain. In 5G, a quantity of resources included in the CORESET 520 may be flexibly configured, such as by using radio resource control (RRC) signaling to indicate a frequency domain region (e.g., a quantity of resource blocks) and/or a time domain region (e.g., a quantity of symbols) for the CORESET 520.

As illustrated, a symbol 515 that includes CORESET 520 may include one or more control channel elements (CCEs) 525, shown as two CCEs 525 as an example, that span a portion of the system bandwidth. A CCE 525 may include DCI that is used to provide control information for wireless communication. A base station may transmit DCI during multiple CCEs 525 (as shown), where the quantity of CCEs 525 used for transmission of DCI represents the aggregation level (AL) used by the BS for the transmission of DCI. In FIG. 5, an aggregation level of two is shown as an example, corresponding to two CCEs 525 in a slot 510. In some aspects, different aggregation levels may be used, such as 1, 2, 4, 8, 16, or another aggregation level.

Each CCE 525 may include a fixed quantity of resource element groups (REGs) 530, shown as 6 REGs 530, or may include a variable quantity of REGs 530. In some aspects, the quantity of REGs 530 included in a CCE 525 may be specified by a REG bundle size. A REG 530 may include one resource block, which may include 12 resource elements (REs) 535 within a symbol 515. A resource element 535 may occupy one subcarrier in the frequency domain and one OFDM symbol in the time domain.

An SS may include all possible locations (e.g., in time and/or frequency) where a PDCCH may be located. A CORESET 520 may include one or more SSs, such as a UE-specific SS, a group-common SS, and/or a common SS. An SS may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as an SS. For example, the set of all possible PDCCH locations for a particular UE may be referred to as a UE-specific SS. Similarly, the set of all possible PDCCH locations across all UEs may be referred to as a common SS. The set of all possible PDCCH locations for a particular group of UEs may be referred to as a group-common SS. One or more SS across aggregation levels may be referred to as an SS set.

A CORESET 520 may be interleaved or non-interleaved. An interleaved CORESET 520 may have CCE-to-REG mapping such that adjacent CCEs are mapped to scattered REG bundles in the frequency domain (e.g., adjacent CCEs are not mapped to consecutive REG bundles of the CORESET 520). A non-interleaved CORESET 520 may have a CCE-to-REG mapping such that all CCEs are mapped to consecutive REG bundles (e.g., in the frequency domain) of the CORESET 520.

A set of SSs may be used to monitor for PDCCH messages. Up to 10 SS sets may be configured per BWP and up to 40 SS sets in total per cell. Different SS sets may be configured for different services. PDCCH candidates per AL for blind detection may be configured per SS set. Each SS may be associated with only one CORESET. The CORESET may be used to configure frequency-domain resources, RE mapping for PDCCH candidates, and the beam/TRP for PDCCH transmission. SS types may include a common SS (CSS) only for RRC_IDLE/INACTIVE and a CSS+UE-specific SS (USS) for RRC_CONN.

In some aspects, a UE may switch between SSSGs, such as between SSSG 540 and SSSG 545. Up to 3 SSSGs (e.g., searchSpaceGroupIdList) may be configured. DCI-based SSSG switching may be supported for RRC_CONN UEs. A searchSpaceSwitchTimer may be configured to switch from SSSG 545 back to SSSG 540.

In some aspects, an SS configuration may indicate a monitoring slot periodicity and offset, a periodicity and offset, a duration in terms of consecutive slots, monitoring slots within slot group (14-bitmap of symbols in a slot), monitoring symbols within slot (4 or 8-bitmap of a slot group), a number of candidates per AL, and/or an associated CORESET (frequency domain parameters, spatial domain parameters).

Example 500 shows duration 550 and duration 555 of an SS 560. The duration may use frequency resources of an associated CORESET. The SS 560 may have an SS periodicity.

As indicated above, FIG. 5 is provided as an example. Other examples may differ from what is described with respect to FIG. 5.

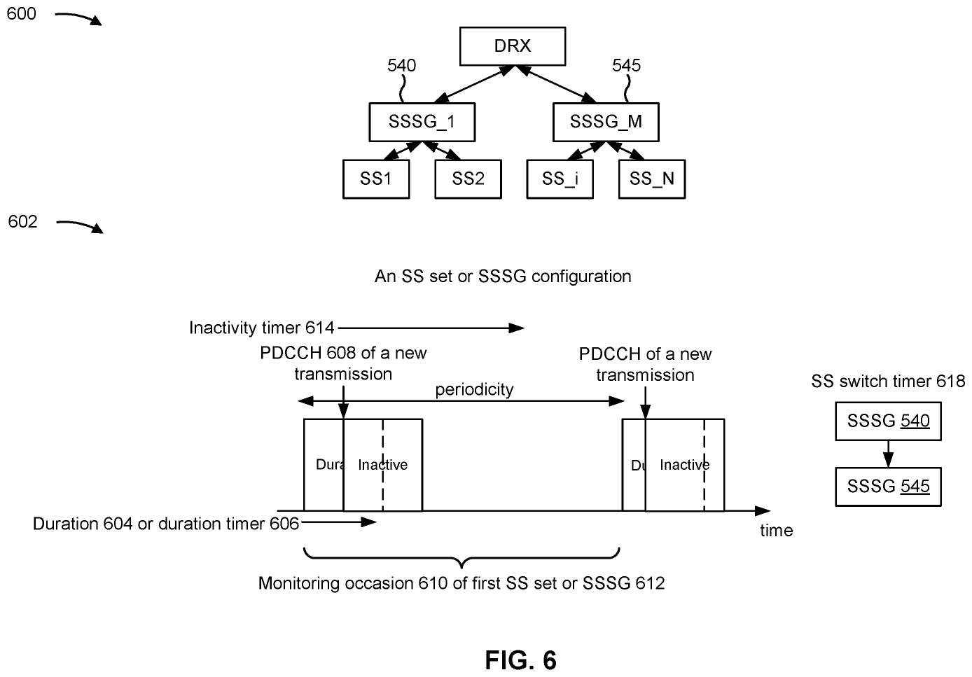

FIG. 6 is a diagram illustrating an example 600 of using both SS and DRX features, in accordance with the present disclosure.

According to various aspects described herein, DRX features may be added to the use of SS sets for an enhanced SS configuration. For example, a network entity may configure a UE with an adaptive timer/periodicity SS, similar to what is used for DRX. Alternatively, or additionally, in some aspects, SS features may be added to DRX for an enhanced DRX configuration. For example, the network entity may configure service-specific DRX with dynamic switching, which is used with SS. Example 600 shows the combination of DRX and SS features. By combining SS features and DRX features, signaling resources may be used more efficiently with DRX and power may be conserved with the use of SS sets.

In some aspects associated with adding DRX features to an enhanced SS configuration, a UE may be configured with one or more adaptive timers to achieve a tradeoff between power saving and latency reduction. As shown in example 602, a network entity may configure a duration 604 or a duration timer 606 and an inactivity timer 614 per SS set or per SSSG. The SSSG may be configured for a group of SS sets associated with a service type. The UE may start the duration 604 or the duration timer 606 at the start of a first SS set or SSSG 612 (e.g., at the start of each monitoring occasion 610).

After the UE receives a PDCCH message 608 indicating a new transmission in the first SS set or SSSG 612, the UE may start or restart the inactivity timer 614 after an end of receiving the PDCCH message 608. The use of the inactivity timer 614 may extend the active time for the first SS set or SSSG 612. Note that the duration 604, the duration timer 606, and the inactivity timer 614 may be different from an SS switch timer 618 that is defined for SSSG switching. The UE may stop monitoring the first SS set or SSSG 612 if the duration 604 or the duration timer 606 expires, but the UE may switch from the first SS set or SSSG to a second SS set or SSSG, such as from SSSG 540 to SSSG 545, if the SS switch timer 618 expires.

In some aspects, the network entity may transmit a command message (e.g., MAC CE) to stop the duration 604, the duration timer 606, and/or the inactivity timer 614 for the first SS set or SSSG 612. The MAC CE may be indicated by unicast PDCCH or multicast PDCCH. With the expiration of the duration 604 or the duration timer 606 and the use of the inactivity timer 614, which are DRX features, the monitoring in SS sets or SSSGs may conserve power.

As indicated above, FIG. 6 is provided as an example. Other examples may differ from what is described with regard to FIG. 6.

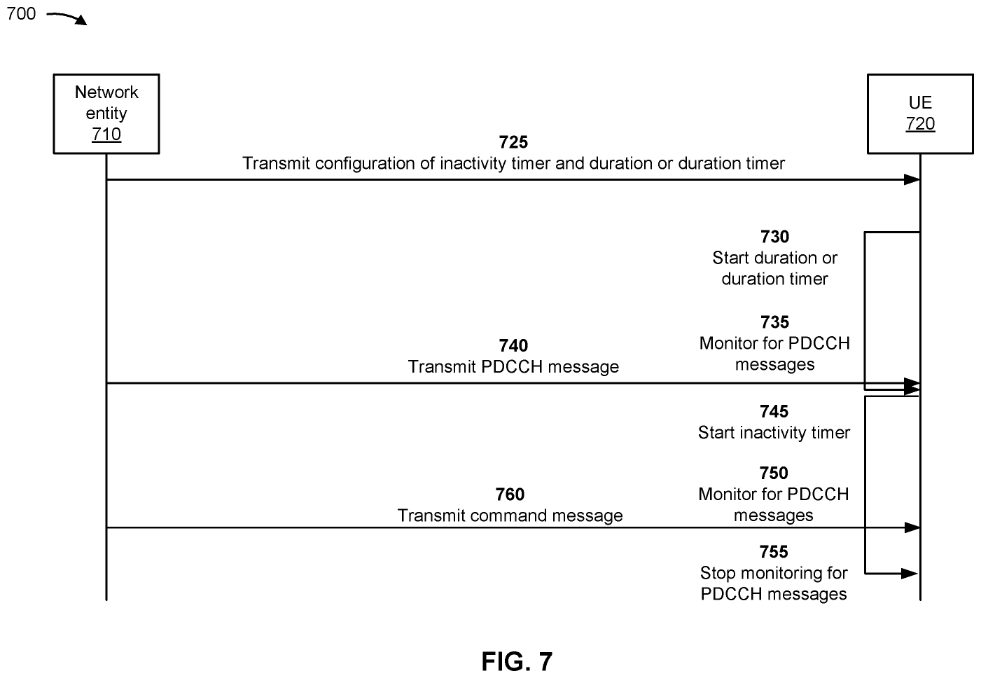

FIG. 7 is a diagram illustrating an example 700 associated with using both SS and DRX features, in accordance with the present disclosure. As shown in FIG. 7, a network entity 710 (e.g., network node 110) and a UE 720 (e.g., UE 120) may communicate with one another.

As shown by reference number 725, the network entity 710 may transmit a configuration of an inactivity timer and a duration or duration timer. As shown by reference number 730, the UE 720 may start the duration or duration timer. The UE 720 may start the duration or duration timer in each monitoring occasion of an SS set or SSSG. As shown by reference number 735, the UE 720 may monitor for PDCCH messages in the monitoring occasion during the duration or duration timer.

As shown by reference number 740, the network entity 710 may transmit a PDCCH message indicating a new transmission. The UE 720 may receive the PDCCH message. As shown by reference number 745, the UE 720 may start an inactivity timer. The inactivity timer may start at an end of receiving the PDCCH message in the SS set or SSSG. As shown by reference number 750, the UE 720 may monitor for PDCCH messages in the SS set or SSSG during the inactivity timer. The inactivity timer may expire and the UE 720 may stop monitoring for PDCCH messages in the SS set or SSSG, as shown by reference number 755. Optionally, in some aspects, the network entity 710 may transmit a command message to stop the inactivity timer, as shown by reference number 760. The UE 720 may enter a sleep state associated with the SS set or SSSG and conserve power until a next scheduled duration (according to a periodicity of the SS set or SSSG).

As indicated above, FIG. 7 is provided as an example. Other examples may differ from what is described with respect to FIG. 7.

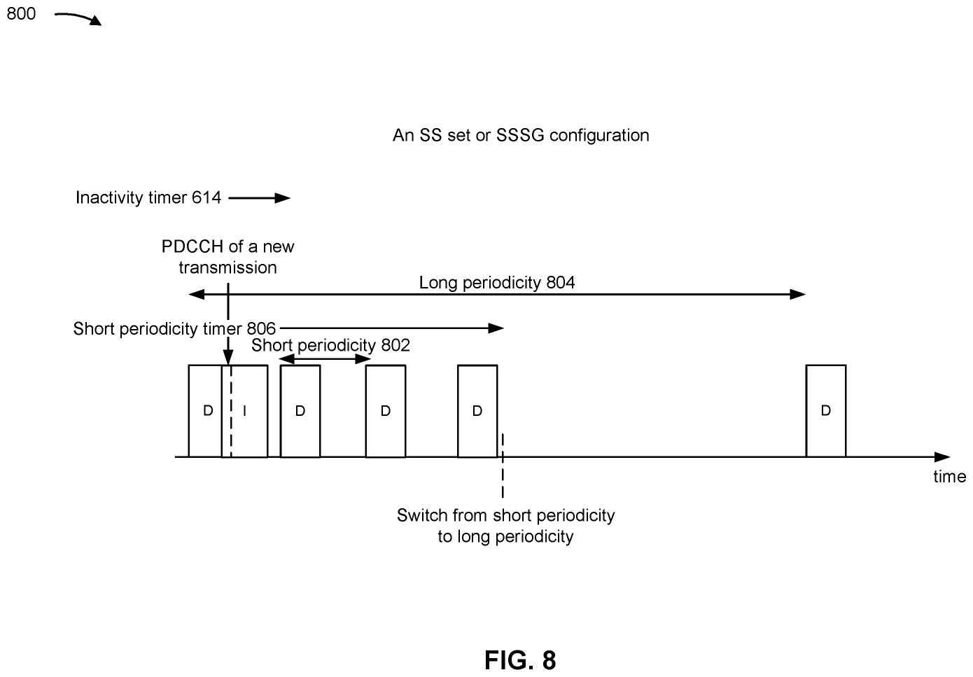

FIG. 8 is a diagram illustrating an example 800 of using SS and DRX features, in accordance with the present disclosure.

In some aspects, a UE may use an adaptive short/long periodicity to handle bursty traffic. Example 800 shows multiple durations (D) (on durations) for monitoring for PDCCH messages in an SS set or SSSG. Example 800 may be separate from or used in combination with examples 600 and 700.

A network entity may configure the UE with a short periodicity 802 (similar as a short DRX cycle) in addition to a long periodicity 804 (similar as a DRX long cycle) per SS set or SSSG. The long periodicity may be a multiple of the short periodicity. The configuration may also configure a short periodicity timer 806 for how long the UE is to use the short periodicity 802 before switching to the long periodicity 804 (upon expiration of the short periodicity timer 806). The short periodicity timer may be configured separately per SS set or SSSG or may be common for all the SS sets or SSSGs configured with the short periodicity. The configuration may configure an inactivity timer (e.g., inactivity timer 614), a duration, and/or a duration timer.

If short periodicity is configured, the UE may start or restart the short periodicity timer 806 for the SS set or SSSG (e.g., in the first symbol after the expiration of the inactivity timer 614) and use the short periodicity 802 for the SS set or SSSG. If the short periodicity timer 806 for the SS set or SSSG expires, the UE may use the long periodicity 804 for the SS set or SSSG.

In some aspects, the UE may receive a command message to stop the short periodicity timer 806. The UE may stop the short periodicity timer and use the long periodicity for the SS set or SSSG. The command message may be a MAC CE in a PDSCH that is scheduled by a unicast PDCCH message or a groupcast PDCCH message.

In some aspects, the UE may transmit a preferred short periodicity for an SS set or SSSG. The UE may transmit a preferred short periodicity timer value for an SS set or SSSG. The UE may transmit an indication of a preferred long periodicity for an SS set or SSSG. The preference indications may enable better power saving at the UE. In some aspects, the UE may indicate the preferences per SS set or SSSG as UE assistance information (UAI).

As indicated above, FIG. 8 is provided as an example. Other examples may differ from what is described with regard to FIG. 8.

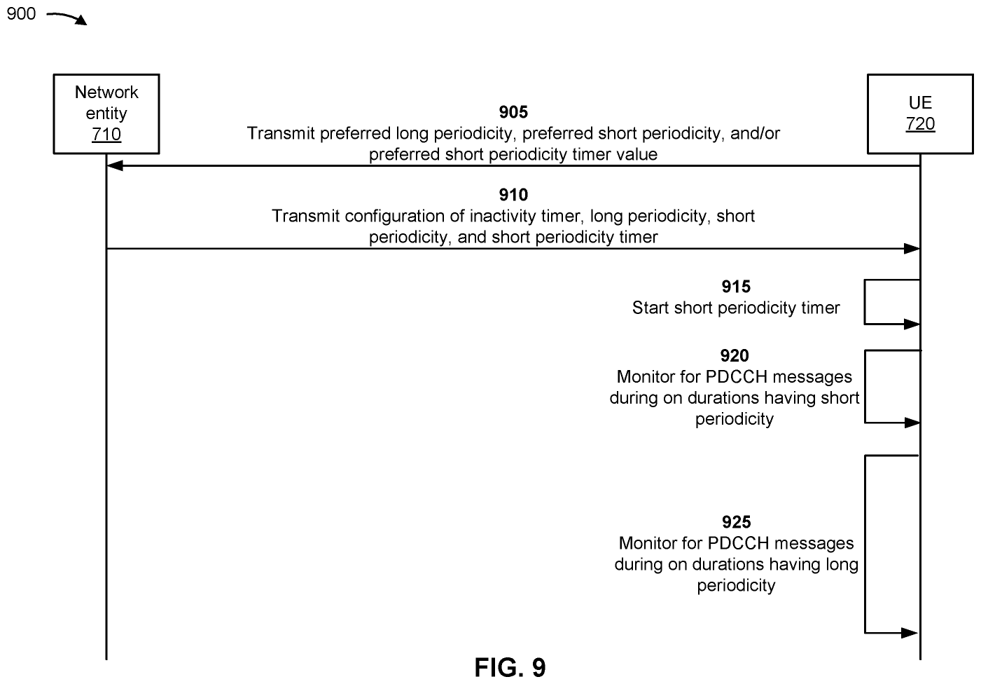

FIG. 9 is a diagram illustrating an example 900 associated with using SS and DRX features, in accordance with the present disclosure.

Example 900 shows use of a short periodicity. As shown by reference number 905, the UE 720 may transmit an indication of a preferred long periodicity, a preferred short periodicity, and/or a preferred short periodicity timer value. As shown by reference number 910, the network entity 710 may transmit a configuration of an inactivity timer, a long periodicity, a short periodicity, and/or a short periodicity timer.

As shown by reference number 915, the UE 720 may start a short periodicity timer. The short periodicity timer may start in a first symbol after the inactivity timer expires. The short periodicity may be specific to an SS set or SSSG. As shown by reference number 920, the UE 720 may monitor for PDCCH messages in on durations having the short periodicity. When the short periodicity timer expires, the UE 720 may switch back to monitoring for PDCCH message in on durations having the long periodicity, as shown by reference number 925. By using on durations closer together in time during bursty traffic, the UE 720 may use signaling resources more efficiently and reduce latency. By switching back to the long periodicity using the short periodicity timer, the UE 720 may conserve power consistent with the benefits of DRX features.

As indicated above, FIG. 9 is provided as an example. Other examples may differ from what is described with regard to FIG. 9.

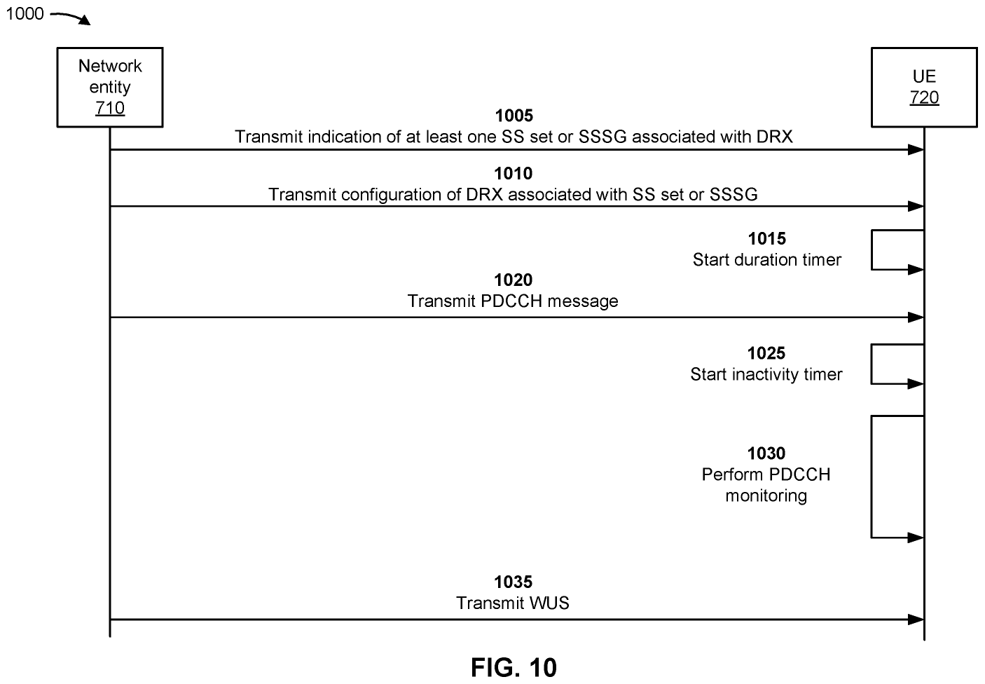

FIG. 10 is a diagram illustrating an example 1000 associated with using SS and DRX features, in accordance with the present disclosure.

In some aspects, SS features may be added to an enhanced DRX configuration. A network entity may enable a service-specific SS for DRX, where the DRX may be associated with at least one SS set or a SSSG with a similar service type. A DRX on duration timer (e.g., drx-OnDurationTimer) and an inactivity timer (e.g., drx-InactiveTimer) may apply to the at least one associated SS set or SSSG.

Example 1000 shows the use of DRX in association with at least one SS set or SSSG. The at least one associated SS set or SSSG may include a subset of configured SS sets or a subset of configured SSSGs. The network entity 710 may transmit an indication of the at least one associated SS set or SSSG, as shown by reference number 1005.

As shown by reference number 1010, the network entity 710 may transmit a configuration for DRX that is associated with at least one SS set or SSSG. The parameters for DRX per SS set or SSSG may be independently configured and if not explicitly configured, a default value may be defined (e.g., using the one of the DRX associated with lowest SS set index or SSSG index). The association between DRX and an SS set or SSSG may be configured by RRC. Alternatively, a subset of SS sets or SSSGs may be activated or deactivated by a MAC CE, and the configuration for DRX may only be applied to the active SS set(s) or SSSG(s). As shown by reference number 1015, the UE 720 may start or restart a duration timer that is applied to each monitoring occasion of the at least one associated SS set or SSSG. As shown by reference number 1020, the network entity 710 may transmit a PDCCH message in a monitoring occasion of the at least one associated SS set or SSSG.

As shown by reference number 1025, the UE 720 may start or restart an inactivity timer for DRX that is applied to the at least one associated SS set or SSSG upon expiration of the duration timer. As shown by reference number 1030, the UE 720 may perform PDCCH monitoring until the inactivity timer expires. By using DRX for associated SS sets or SSSGs, the UE 720 may use signaling resources more efficiently.

In some aspects, a WUS configured for the DRX may apply to the at least one associated SS set or SSSG. The SS/SSSG indication may be based at least in part on different WUS sequences or included in a WUS-PDCCH. Alternatively, a subset of SS sets or SSSGs may be activated or deactivated by a MAC CE and the WUS sequence or WUS PDCCH bit field may only be applied to the active SS set(s) or SSSG(s). As shown by reference number 1035, the network entity 710 may transmit a WUS to start another on duration.

As indicated above, FIG. 10 is provided as an example. Other examples may differ from what is described with regard to FIG. 10.

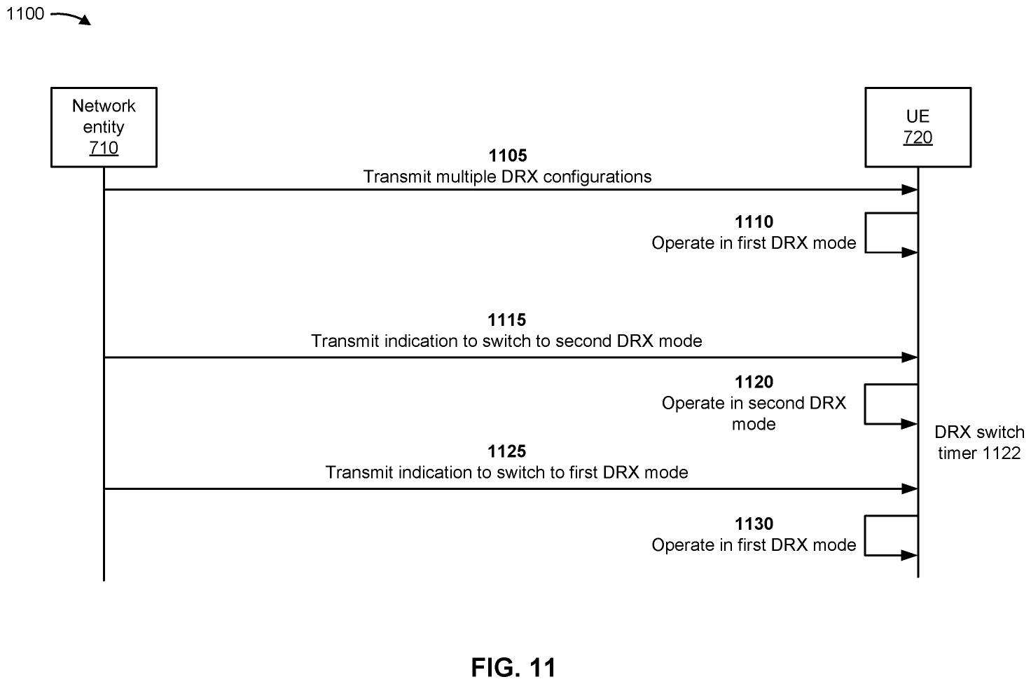

FIG. 11 is a diagram illustrating an example 1100 associated with using SS and DRX features, in accordance with the present disclosure.

In some aspects, a network entity may enable dynamic DRX switching, similar to SS switching. As shown by reference number 1105, the network entity 710 may transmit multiple DRX configurations (e.g., via RRC signaling), including a first DRX configuration and a second DRX configuration. As shown by reference number 1110, the UE 720 may operate in a first DRX mode according to the first DRX configuration.

The DRX switching may be dynamic. A PDCCH message (e.g., DCI) may be used to indicate switching to a DRX mode. As shown by reference number 1115, the network entity 710 may transmit an indication (e.g., DCI) to switch to a second DRX mode. As shown by reference number 1120, the UE 720 may operate in the second DRX mode according to the second DRX configuration.

In some aspects, the UE 720 may use a DRX switch timer 1122, which starts when the UE 720 switches to the second DRX mode. Upon expiration of the DRX switch timer 1122, the UE 720 may switch back to the first DRX mode.

In some aspects, the network entity 710 may transmit an indication to switch back to the first DRX mode, as shown by reference number 1125. As shown by reference number 1130, the UE 720 may switch back to and operate in the first DRX mode.

By using an SS switching feature to enhance a DRX configuration that enables DRX switching for one or more SS sets or SSSGs, the UE 720 may use a DRX mode that is more appropriate for traffic or channel conditions (e.g., the network entity 710 may select the DRX mode based at least in part on traffic or channel conditions). Using appropriate and timely DRX configurations allows for power conservation without degrading communications. Latency is reduced and signaling resources are conserved.

As indicated above, FIG. 11 is provided as an example. Other examples may differ from what is described with respect to FIG. 11.

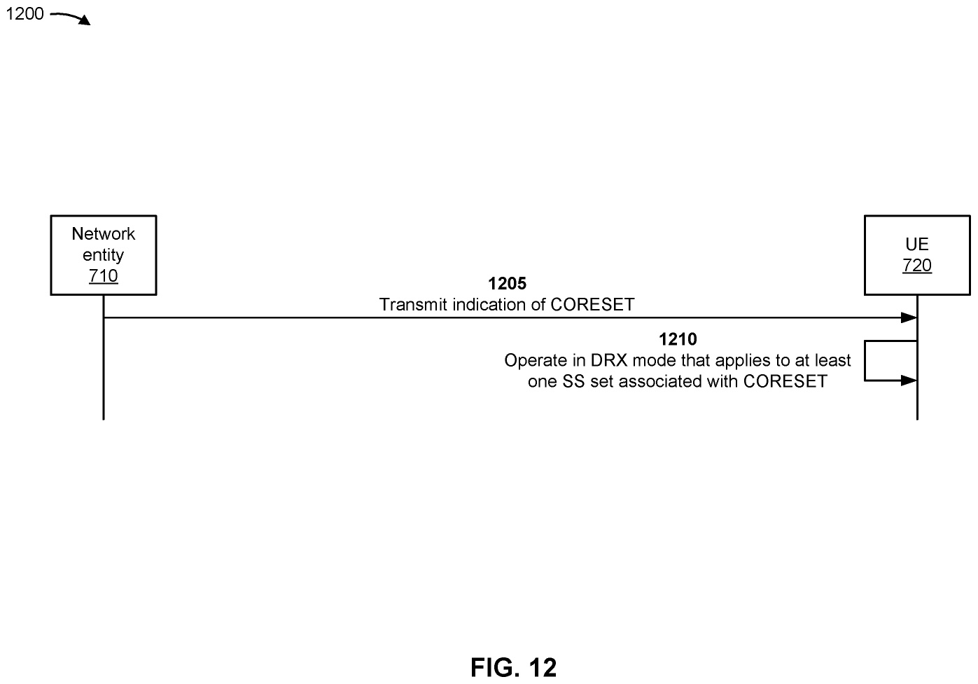

FIG. 12 is a diagram illustrating an example 1200 associated with using SS and DRX features, in accordance with the present disclosure.

In some aspects, a network entity may enable DRX to be associated with a CORESET. The CORESET may be associated with one or multiple SS sets or SSSGs. The CORESET may include frequency domain parameters and/or spatial domain parameters.

Example 1200 shows operating in a DRX mode that applied to SS sets associated with a CORESET. As shown by reference number 1205, the network entity 710 may transmit an indication of a CORESET. As shown by reference number 1210, the UE 720 may operate in a DRX mode that applies to a least one SS set associated with the CORESET. By combining a DRX mode and SS features associated with a CORESET, the UE 720 may conserve power while using SS sets associated with the CORESET.

As indicated above, FIG. 12 is provided as an example. Other examples may differ from what is described with regard to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120, UE 720) performs operations associated with using DRX and SS features together.

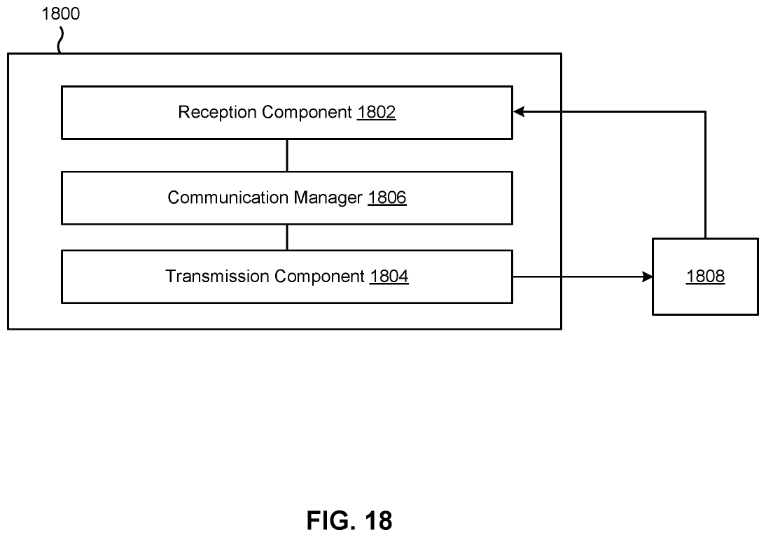

As shown in FIG. 13, in some aspects, process 1300 may include receiving a configuration of a duration or a duration timer, and of an inactivity timer of a first SS set or SSSG (block 1310). For example, the UE (e.g., using reception component 1802 and/or communication manager 1806, depicted in FIG. 18) may receive a configuration of a duration or a duration timer, and of an inactivity timer of a first SS set or SSSG, as described above.

As further shown in FIG. 13, in some aspects, process 1300 may include starting the duration or the duration timer in each monitoring occasion of the first SS set or SSSG (block 1320). For example, the UE (e.g., using communication manager 1806, depicted in FIG. 18) may start the duration or the duration timer in each monitoring occasion of the first SS set or SSSG, as described above.

As further shown in FIG. 13, in some aspects, process 1300 may include receiving, in a monitoring occasion of the first SS set or SSSG within the duration or before the duration timer expires, a PDCCH message indicating a new transmission in the first SS set or SSSG (block 1330). For example, the UE (e.g., using reception component 1802 and/or communication manager 1806, depicted in FIG. 18) may receive, in a monitoring occasion of the first SS set or SSSG within the duration or before the duration timer expires, a PDCCH message indicating a new transmission in the first SS set or SSSG, as described above.

As further shown in FIG. 13, in some aspects, process 1300 may include starting or restarting the inactivity timer for the monitoring occasion of the first SS set or SSSG after an end of receiving the PDCCH message (block 1340). For example, the UE (e.g., using communication manager 1806, depicted in FIG. 18) may start or restart the inactivity timer for the monitoring occasion of the first SS set or SSSG after an end of receiving the PDCCH message, as described above.

As further shown in FIG. 13, in some aspects, process 1300 may include monitoring for PDCCH messages during the inactivity timer (block 1350). For example, the UE (e.g., using communication manager 1806, depicted in FIG. 18) may monitor for PDCCH messages during the inactivity timer, as described above.

Process 1300 may include additional aspects, such as any single aspect or any combination of aspects described below and/or in connection with one or more other processes described elsewhere herein.

In a first aspect, process 1300 includes stopping monitoring for PDCCH messages upon expiration of the inactivity timer.

In a second aspect, alone or in combination with the first aspect, process 1300 includes receiving a command message to stop the duration timer, the inactivity timer, or both, and stopping the duration timer, the inactivity timer, or both.

In a third aspect, alone or in combination with one or more of the first and second aspects, the command message is a MAC CE in a physical downlink shared channel (PDSCH) scheduled by a unicast PDCCH message.

In a fourth aspect, alone or in combination with one or more of the first through third aspects, the command message is a MAC CE in a PDSCH scheduled by a groupcast PDCCH message.

In a fifth aspect, alone or in combination with one or more of the first through fourth aspects, process 1300 includes switching to a second SS set or SSSG upon expiration of an SSSG switch timer.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a UE or an apparatus of a UE, in accordance with the present disclosure. Example process 1400 is an example where the apparatus or the UE (e.g., UE 120, UE 720) performs operations associated with using DRX and SS features together.

As shown in FIG. 14, in some aspects, process 1400 may include receiving a configuration of an inactivity timer, a long periodicity, a short periodicity, and a short periodicity timer of a first SS set or SSSG (block 1410). For example, the UE (e.g., using reception component 1802 and/or communication manager 1806, depicted in FIG. 18) may receive a configuration of an inactivity timer, a long periodicity, a short periodicity, and a short periodicity timer of a first SS set or SSSG, as described above.

As further shown in FIG. 14, in some aspects, process 1400 may include starting or restarting, in a first symbol after an inactivity timer for the first SS set or SSSG expires, a short periodicity timer for on durations having a short periodicity that is shorter than a long periodicity used for the first SS set or SSSG (block 1420). For example, the UE (e.g., using communication manager 1806, depicted in FIG. 18) may start or restart, in a first symbol after an inactivity timer for the first SS set or SSSG expires, a short periodicity timer for on durations having a short periodicity that is shorter than a long periodicity used for the first SS set or SSSG, as described above.

As further shown in FIG. 14, in some aspects, process 1400 may include monitoring for PDCCH messages in the first SS set or SSSG during the on durations having the short periodicity (block 1430). For example, the UE (e.g., using communication manager 1806, depicted in FIG. 18) may monitor for PDCCH messages in the first SS set or SSSG during the on durations having the short periodicity, as described above.

As further shown in FIG. 14, in some aspects, process 1400 may include monitoring, after the short periodicity timer expires, for PDCCH messages in the first SS set or SSSG during on durations having the long periodicity (block 1440). For example, the UE (e.g., using communication manager 1806, depicted in FIG. 18) may monitor, after the short periodicity timer expires, for PDCCH messages in the first SS set or SSSG during on durations having the long periodicity, as described above.

Process 1400 may include additional aspects, such as any single aspect or any combination of aspects described below and/or in connection with one or more other processes described elsewhere herein.

In a first aspect, the long periodicity is a multiple of the short periodicity used for the first SS or SSSG.

In a second aspect, alone or in combination with the first aspect, process 1400 includes receiving a command message to stop the short periodicity timer, and stopping the short periodicity timer and using the long periodicity for the first SS or SSSG.

In a third aspect, alone or in combination with one or more of the first and second aspects, the command message is a MAC CE in a PDSCH scheduled by a unicast PDCCH message.

In a fourth aspect, alone or in combination with one or more of the first through third aspects, the command message is a MAC CE in a PDSCH scheduled by a groupcast PDCCH message.

In a fifth aspect, alone or in combination with one or more of the first through fourth aspects, process 1400 includes transmitting an indication of a preferred short periodicity for the first SS set or SSSG.

In a sixth aspect, alone or in combination with one or more of the first through fifth aspects, process 1400 includes transmitting an indication of a preferred short periodicity timer value for the first SS set or SSSG.

In a seventh aspect, alone or in combination with one or more of the first through sixth aspects, process 1400 includes transmitting an indication of a preferred long periodicity for the first SS set or SSSG.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a UE or an apparatus of a UE, in accordance with the present disclosure. Example process 1500 is an example where the apparatus or the UE (e.g., UE 120, UE 720) performs operations associated with using DRX and SS features together.

As shown in FIG. 15, in some aspects, process 1500 may include receiving a configuration of a DRX associated with at least one SS set or SSSG (block 1510). For example, the UE (e.g., using reception component 1802 and/or communication manager 1806, depicted in FIG. 18) may receive a configuration of a DRX associated with at least one SS set or SSSG, as described above.

As further shown in FIG. 15, in some aspects, process 1500 may include starting a duration timer for DRX that is applied to each monitoring occasion of the at least one associated SS set or SSSG (block 1520). For example, the UE (e.g., using communication manager 1806, depicted in FIG. 18) may start a duration timer for DRX that is applied to each monitoring occasion of the at least one associated SS set or SSSG, as described above.

As further shown in FIG. 15, in some aspects, process 1500 may include receiving a PDCCH message indicating a new transmission in the at least one associated SS set or SSSG (block 1530). For example, the UE (e.g., using reception component 1802 and/or communication manager 1806, depicted in FIG. 18) may receive a PDCCH message indicating a new transmission in the at least one associated SS set or SSSG, as described above.

As further shown in FIG. 15, in some aspects, process 1500 may include starting an inactivity timer for DRX that is applied to the at least one associated SS set or SSSG upon expiration of the duration timer (block 1540). For example, the UE (e.g., using communication manager 1806, depicted in FIG. 18) may start an inactivity timer for DRX that is applied to the at least one associated SS set or SSSG upon expiration of the duration timer, as described above.

As further shown in FIG. 15, in some aspects, process 1500 may include performing PDCCH monitoring until the inactivity timer expires (block 1550). For example, the UE (e.g., using communication manager 1806, depicted in FIG. 18) may perform PDCCH monitoring until the inactivity timer expires, as described above.

Process 1500 may include additional aspects, such as any single aspect or any combination of aspects described below and/or in connection with one or more other processes described elsewhere herein.

In a first aspect, the at least one associated SS set or SSSG includes a subset of configured SS sets or a subset of configured SSSGs.

In a second aspect, alone or in combination with the first aspect, process 1500 includes receiving an indication of the at least one associated SS set or SSSG.

In a third aspect, alone or in combination with one or more of the first and second aspects, process 1500 includes receiving a wake up signal for DRX that is associated with the at least one associated SS set or SSSG.

In a fourth aspect, alone or in combination with one or more of the first through third aspects, process 1500 includes receiving an indication of a CORESET, and operating in a DRX mode that applies to the at least one SS set, where the at least one SS set is associated with the CORESET.

In a fifth aspect, alone or in combination with one or more of the first through fourth aspects, the CORESET is associated with multiple SS sets.

In a sixth aspect, alone or in combination with one or more of the first through fifth aspects, the CORESET includes one or more frequency domain parameters or spatial domain parameters.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a UE or an apparatus of a UE, in accordance with the present disclosure. Example process 1600 is an example where the apparatus or the UE (e.g., UE 120, UE 720) performs operations associated with using DRX and SS features together.

As shown in FIG. 16, in some aspects, process 1600 may include receiving multiple DRX configurations (block 1610). For example, the UE (e.g., using reception component 1802 and/or communication manager 1806, depicted in FIG. 18) may receive multiple DRX configurations, as described above.

As further shown in FIG. 16, in some aspects, process 1600 may include operating in a first DRX mode in accordance with a first DRX configuration of the multiple DRX configurations (block 1620). For example, the UE (e.g., using communication manager 1806, depicted in FIG. 18) may operate in a first DRX mode in accordance with a first DRX configuration of the multiple DRX configurations, as described above.

As further shown in FIG. 16, in some aspects, process 1600 may include receiving a first indication to switch to a second DRX mode (block 1630). For example, the UE (e.g., using reception component 1802 and/or communication manager 1806, depicted in FIG. 18) may receive a first indication to switch to a second DRX mode, as described above.

As further shown in FIG. 16, in some aspects, process 1600 may include operating in the second DRX mode in accordance with a second DRX configuration of the multiple DRX configurations (block 1640). For example, the UE (e.g., using communication manager 1806, depicted in FIG. 18) may operate in the second DRX mode in accordance with a second DRX configuration of the multiple DRX configurations, as described above.

Process 1600 may include additional aspects, such as any single aspect or any combination of aspects described below and/or in connection with one or more other processes described elsewhere herein.

In a first aspect, process 1600 includes receiving a second indication to switch to the first DRX mode, and operating in the first DRX mode.

In a second aspect, alone or in combination with the first aspect, one or more of the first indication or the second indication is included in downlink control information.

In a third aspect, alone or in combination with one or more of the first and second aspects, process 1600 includes receiving a DRX switch timer associated with a DRX switching configuration, starting the DRX switch timer at a start of the second DRX mode, switching back to the first DRX upon expiration of the DRX switch timer, and operating in the first DRX mode.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a UE or an apparatus of a UE, in accordance with the present disclosure. Example process 1700 is an example where the apparatus or the UE (e.g., UE 120, UE 720) performs operations associated with using DRX and SS features together.

As shown in FIG. 17, in some aspects, process 1700 may include receiving an indication of a CORESET (block 1710). For example, the UE (e.g., using reception component 1802 and/or communication manager 1806, depicted in FIG. 18) may receive an indication of a CORESET, as described above.

As further shown in FIG. 17, in some aspects, process 1700 may include operating in a DRX mode that applies to at least one SS set associated with the CORESET (block 1720). For example, the UE (e.g., using communication manager 1806, depicted in FIG. 18) may operate in a DRX mode that applies to at least one SS set associated with the CORESET, as described above.

Process 1700 may include additional aspects, such as any single aspect or any combination of aspects described below and/or in connection with one or more other processes described elsewhere herein.

In a first aspect, the CORESET is associated with multiple SS sets.

In a second aspect, alone or in combination with the first aspect, the CORESET includes one or more frequency domain parameters or spatial domain parameters.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a UE, or a UE may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 140 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 1-12. Additionally, or alternatively, the apparatus 1800 may be configured to perform one or more processes described herein, such as process 1300 of FIG. 13, process 1400 of FIG. 14, process 1500 of FIG. 15, process 1600 of FIG. 16, process 1700 of FIG. 17, or a combination thereof. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1804 may be co-located with the reception component 1802 in one or more transceivers.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

In some aspects, the reception component 1802 may receive a configuration of a duration or a duration timer, and of an inactivity timer of a first SS set or SSSG. The communication manager 1806 may start the duration or the duration timer in each monitoring occasion of the first SS set or SSSG. The reception component 1802 may receive, in a monitoring occasion of the first SS set or SSSG within the duration or before the duration timer expires, a PDCCH message indicating a new transmission in the first SS set or SSSG. The communication manager 1806 may start or restart the inactivity timer for the monitoring occasion of the first SS set or SSSG after an end of receiving the PDCCH message. The communication manager 1806 may monitor for PDCCH messages during the inactivity timer.

The communication manager 1806 may stop monitoring for PDCCH messages upon expiration of the inactivity timer. The reception component 1802 may receive a command message to stop the duration timer, the inactivity timer, or both. The communication manager 1806 may stop the duration timer, the inactivity timer, or both. The communication manager 1806 may switch to a second SS set or SSSG upon expiration of an SSSG switch timer.

In some aspects, the reception component 1802 may receive a configuration of an inactivity timer, a long periodicity, a short periodicity, and a short periodicity timer of a first SS set or SSSG. The communication manager 1806 may start or restart, in a first symbol after an inactivity timer for the first SS set or SSSG expires, a short periodicity timer for on durations having a short periodicity that is shorter than a long periodicity used for the first SS set or SSSG. The communication manager 1806 may monitor for PDCCH messages in the first SS set or SSSG during the on durations having the short periodicity. The communication manager 1806 may monitor, after the short periodicity timer expires, for PDCCH messages in the first SS set or SSSG during on durations having the long periodicity.

The reception component 1802 may receive a command message to stop the short periodicity timer. The communication manager 1806 may stop the short periodicity timer and use the long periodicity for the first SS or SSSG. The transmission component 1804 may transmit an indication of a preferred short periodicity for the first SS set or SSSG. The transmission component 1804 may transmit an indication of a preferred short periodicity timer value for the first SS set or SSSG. The transmission component 1804 may transmit an indication of a preferred long periodicity for the first SS set or SSSG.

In some aspects, the reception component 1802 may receive a configuration of a DRX associated with at least one SS set or SSSG. The communication manager 1806 may start a duration timer for DRX that is applied to each monitoring occasion of the at least one associated SS set or SSSG. The reception component 1802 may receive a PDCCH message indicating a new transmission in the at least one associated SS set or SSSG. The communication manager 1806 may start an inactivity timer for DRX that is applied to the at least one associated SS set or SSSG upon expiration of the duration timer. The communication manager 1806 may perform PDCCH monitoring until the inactivity timer expires.

The reception component 1802 may receive an indication of the at least one associated SS set or SSSG. The reception component 1802 may receive a WUS for DRX that is associated with the at least one associated SS set or SSSG.

The reception component 1802 may receive an indication of a CORESET. The communication manager 1806 may operate in a DRX mode that applies to the at least one SS set, where the at least one SS set is associated with the CORESET.

In some aspects, the reception component 1802 may receive multiple DRX configurations. The communication manager 1806 may operate in a first DRX mode in accordance with a first DRX configuration of the multiple DRX configurations. The reception component 1802 may receive a first indication to switch to a second DRX mode. The communication manager 1806 may operate in the second DRX mode in accordance with a second DRX configuration of the multiple DRX configurations.

The reception component 1802 may receive a second indication to switch to the first DRX mode. The communication manager 1806 may operate in the first DRX mode.

The reception component 1802 may receive a DRX switch timer associated with a DRX switching configuration. The communication manager 1806 may start the DRX switch timer at a start of the second DRX mode. The communication manager 1806 may switch back to the first DRX upon expiration of the DRX switch timer. The communication manager 1806 may operate in the first DRX mode.

In some aspects, the reception component 1802 may receive an indication of a CORESET. The communication manager 1806 may operate in a DRX mode that applies to at least one SS set associated with the CORESET.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

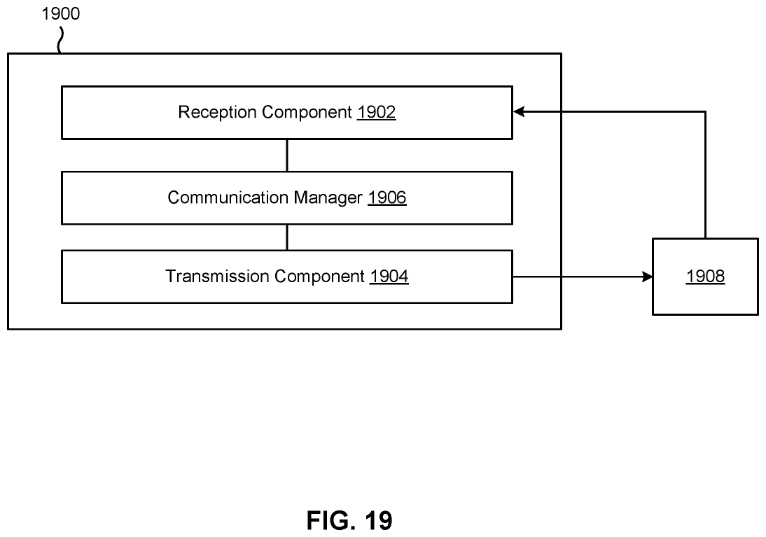

FIG. 19 is a diagram of an example apparatus 1900 for wireless communication, in accordance with the present disclosure. The apparatus 1900 may be a network entity, or a network entity may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 1-12. Additionally, or alternatively, the apparatus 1900 may be configured to perform one or more processes described herein, such as process 1300 of FIG. 13, process 1400 of FIG. 14, process 1500 of FIG. 15, process 1600 of FIG. 16, process 1700 of FIG. 17, or a combination thereof. In some aspects, the apparatus 1900 and/or one or more components shown in FIG. 19 may include one or more components of the network entity described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1904 may be co-located with the reception component 1902 in one or more transceivers.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

In some aspects, the components of the apparatus 1900 may perform network entity operations that carry out the processes described in connection with FIGS. 4-17.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:

Aspect 1: A method of wireless communication performed by a user equipment (UE), comprising: receiving a configuration of a duration or a duration timer, and of an inactivity timer of a first search space (SS) set or SS set group (SSSG); starting the duration or the duration timer in each monitoring occasion of the first SS set or SSSG; receiving, in a monitoring occasion of the first SS set or SSSG within the duration or before the duration timer expires, a physical downlink control channel (PDCCH) message indicating a new transmission in the first SS set or SSSG; starting or restarting the inactivity timer for the monitoring occasion of the first SS set or SSSG after an end of receiving the PDCCH message; and monitoring for PDCCH messages during the inactivity timer.

Aspect 2: The method of Aspect 1, further comprising stopping monitoring for PDCCH messages upon expiration of the inactivity timer.

Aspect 3: The method of any of Aspects 1-2, further comprising: receiving a command message to stop the duration timer, the inactivity timer, or both; and stopping the duration timer, the inactivity timer, or both.

Aspect 4: The method of Aspect 3, wherein the command message is a medium access control control element (MAC CE) in a physical downlink shared channel (PDSCH) scheduled by a unicast PDCCH message.

Aspect 5: The method of Aspect 3, wherein the command message is a medium access control control element (MAC CE) in a physical downlink shared channel (PDSCH) scheduled by a groupcast PDCCH message.

Aspect 6: The method of any of Aspects 1-5, further comprising switching to a second SS set or SSSG upon expiration of an SSSG switch timer.

Aspect 7: A method of wireless communication performed by a user equipment (UE), comprising: receiving a configuration of an inactivity timer, a long periodicity, a short periodicity, and a short periodicity timer of a first search space (SS) set or SS set group (SSSG); starting or restarting, in a first symbol after an inactivity timer for the first SS set or SSSG expires, a short periodicity timer for on durations having a short periodicity that is shorter than a long periodicity used for the first SS set or SSSG; monitoring for physical downlink control channel (PDCCH) messages in the first SS set or SSSG during the on durations having the short periodicity; and monitoring, after the short periodicity timer expires, for PDCCH messages in the first SS set or SSSG during on durations having the long periodicity.

Aspect 8: The method of Aspect 7, wherein the long periodicity is a multiple of the short periodicity used for the first SS or SSSG.

Aspect 9: The method of any of Aspects 7-8, further comprising: receiving a command message to stop the short periodicity timer; and stopping the short periodicity timer and using the long periodicity for the first SS or SSSG.

Aspect 10: The method of Aspect 9, wherein the command message is a medium access control control element (MAC CE) in a physical downlink shared channel (PDSCH) scheduled by a unicast PDCCH message.

Aspect 11: The method of Aspect 9, wherein the command message is a medium access control control element (MAC CE) in a physical downlink shared channel (PDSCH) scheduled by a groupcast PDCCH message.

Aspect 12: The method of any of Aspects 7-11, further comprising transmitting an indication of a preferred short periodicity for the first SS set or SSSG.

Aspect 13: The method of any of Aspects 7-12, further comprising transmitting an indication of a preferred short periodicity timer value for the first SS set or SSSG.

Aspect 14: The method of any of Aspects 7-13, further comprising transmitting an indication of a preferred long periodicity for the first SS set or SSSG.

Aspect 15: A method of wireless communication performed by a user equipment (UE), comprising: receiving a configuration of a discontinuous reception (DRX) associated with at least one search space (SS) set or SS set group (SSSG); starting a duration timer for DRX that is applied to each monitoring occasion of the at least one associated SS set or SSSG; receiving a physical downlink control channel (PDCCH) message indicating a new transmission in the at least one associated SS set or SSSG; starting an inactivity timer for DRX that is applied to the at least one associated SS set or SSSG upon expiration of the duration timer; and performing PDCCH monitoring until the inactivity timer expires.

Aspect 16: The method of Aspect 15, wherein the at least one associated SS set or SSSG includes a subset of configured SS sets or a subset of configured SSSGs.

Aspect 17: The method of any of Aspects 15-16, further comprising receiving an indication of the at least one associated SS set or SSSG.

Aspect 18: The method of any of Aspects 15-17, further comprising receiving a wake up signal for DRX that is associated with the at least one associated SS set or SSSG.

Aspect 19: The method of any of Aspects 15-18, further comprising: receiving an indication of a control resource set (CORESET); and operating in a DRX mode that applies to the at least one SS set, wherein the at least one SS set is associated with the CORESET.

Aspect 20: The method of Aspect 19, wherein the CORESET is associated with multiple SS sets.

Aspect 21: The method of Aspect 19, wherein the CORESET includes one or more frequency domain parameters or spatial domain parameters.

Aspect 22: A method of wireless communication performed by a user equipment (UE), comprising: receiving multiple discontinuous reception (DRX) configurations; operating in a first DRX mode in accordance with a first DRX configuration of the multiple DRX configurations; receiving a first indication to switch to a second DRX mode; and operating in the second DRX mode in accordance with a second DRX configuration of the multiple DRX configurations.

Aspect 23: The method of Aspect 22, further comprising: receiving a second indication to switch to the first DRX mode; and operating in the first DRX mode.

Aspect 24: The method of Aspect 23, wherein one or more of the first indication or the second indication is included in downlink control information.

Aspect 25: The method of any of Aspects 22-24, further comprising: receiving a DRX switch timer associated with a DRX switching configuration; starting the DRX switch timer at a start of the second DRX mode; switching back to the first DRX upon expiration of the DRX switch timer; and operating in the first DRX mode.

Aspect 26: A method of wireless communication performed by a user equipment (UE), comprising: receiving an indication of a control resource set (CORESET); and operating in a discontinuous reception (DRX) mode that applies to at least one search space (SS) set associated with the CORESET.

Aspect 27: The method of Aspect 26, wherein the CORESET is associated with multiple SS sets.

Aspect 28: The method of Aspect 27, wherein the CORESET includes one or more frequency domain parameters or spatial domain parameters.

Aspect 29: The method of Aspect 28, wherein the CORESET is associated with multiple SS sets.

Aspect 30: The method of Aspect 28, wherein the CORESET includes one or more frequency domain parameters or spatial domain parameters.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, individually or collectively configured to cause the UE to:
receive a configuration of a duration or a duration timer, and of an inactivity timer of a first search space (SS) set or SS set group (SSSG);
start the duration or the duration timer in each monitoring occasion of the first SS set or SSSG;
receive, in a monitoring occasion of the first SS set or SSSG within the duration or before the duration timer expires, a physical downlink control channel (PDCCH) message indicating a new transmission in the first SS set or SSSG;
start or restart the inactivity timer for the monitoring occasion of the first SS set or SSSG after an end of receiving the PDCCH message; and
monitor for PDCCH messages during the inactivity timer.

2. The apparatus of claim 1, wherein the one or more processors are individually or collectively configured to cause the UE to stop monitoring for PDCCH messages upon expiration of the inactivity timer.

3. The apparatus of claim 1, wherein the one or more processors are individually or collectively configured to cause the UE to:
receive a command message to stop the duration timer, the inactivity timer, or both; and
stop the duration timer, the inactivity timer, or both.

4. The apparatus of claim 3, wherein the command message is a medium access control control element (MAC CE) in a physical downlink shared channel (PDSCH) scheduled by a unicast PDCCH message.

5. The apparatus of claim 3, wherein the command message is a medium access control control element (MAC CE) in a physical downlink shared channel (PDSCH) scheduled by a groupcast PDCCH message.

6. The apparatus of claim 1, wherein the one or more processors are individually or collectively configured to cause the UE to switch to a second SS set or SSSG upon expiration of an SSSG switch timer.

7. An apparatus for wireless communication at a user equipment (UE), comprising:
one or more memories; and
one or more processors, coupled to the one or more memories, configured to cause the UE to:
receive a configuration of an inactivity timer, a long periodicity, a short periodicity, and a short periodicity timer of a first search space (SS) set or SS set group (SSSG);
start or restart, in a first symbol after an inactivity timer for the first SS set or SSSG expires, a short periodicity timer for on durations having a short periodicity that is shorter than a long periodicity used for the first SS set or SSSG;
monitor for physical downlink control channel (PDCCH) messages in the first SS set or SSSG during the on durations having the short periodicity; and
monitor, after the short periodicity timer expires, for PDCCH messages in the first SS set or SSSG during on durations having the long periodicity.

8. The apparatus of claim 7, wherein the long periodicity is a multiple of the short periodicity used for the first SS or SSSG.

9. The apparatus of claim 7, wherein the one or more processors are individually or collectively configured to cause the UE to:
receive a command message to stop the short periodicity timer; and
stop the short periodicity timer and use the long periodicity for the first SS or SSSG.

10. The apparatus of claim 9, wherein the command message is a medium access control control element (MAC CE) in a physical downlink shared channel (PDSCH) scheduled by a unicast PDCCH message.

11. The apparatus of claim 9, wherein the command message is a medium access control control element (MAC CE) in a physical downlink shared channel (PDSCH) scheduled by a groupcast PDCCH message.

12. The apparatus of claim 7, wherein the one or more processors are individually or collectively configured to cause the UE to transmit an indication of a preferred short periodicity for the first SS set or SSSG.

13. The apparatus of claim 7, wherein the one or more processors are individually or collectively configured to cause the UE to transmit an indication of a preferred short periodicity timer value for the first SS set or SSSG.

14. The apparatus of claim 7, wherein the one or more processors are individually or collectively configured to cause the UE to transmit an indication of a preferred long periodicity for the first SS set or SSSG.

15. An apparatus for wireless communication at a user equipment (UE), comprising:
one or more memories; and
one or more processors, coupled to the one or more memories, configured to cause the UE to:
receive a configuration of a discontinuous reception (DRX) associated with at least one search space (SS) set or SS set group (SSSG);
start a duration timer for DRX that is applied to each monitoring occasion of the at least one associated SS set or SSSG;
receive a physical downlink control channel (PDCCH) message indicating a new transmission in the at least one associated SS set or SSSG;
start an inactivity timer for DRX that is applied to the at least one associated SS set or SSSG upon expiration of the duration timer; and
perform PDCCH monitoring until the inactivity timer expires.

16. The apparatus of claim 15, wherein the at least one associated SS set or SSSG includes a subset of configured SS sets or a subset of configured SSSGs.

17. The apparatus of claim 15, wherein the one or more processors are individually or collectively configured to cause the UE to receive an indication of the at least one associated SS set or SSSG.

18. The apparatus of claim 15, wherein the one or more processors are individually or collectively configured to cause the UE to receive a wake up signal for DRX that is associated with the at least one associated SS set or SSSG.

19. The apparatus of claim 15, wherein the one or more processors are individually or collectively configured to:
receive an indication of a control resource set (CORESET); and
operate in a DRX mode that applies to the at least one SS set, wherein the at least one SS set is associated with the CORESET.

20. The apparatus of claim 19, wherein the CORESET is associated with multiple SS sets.

21. The apparatus of claim 19, wherein the CORESET includes one or more frequency domain parameters or spatial domain parameters.

22. An apparatus for wireless communication at a user equipment (UE), comprising:
one or more memories; and
one or more processors, coupled to the one or more memories, configured to cause the UE to:
receive multiple discontinuous reception (DRX) configurations;
operate in a first DRX mode in accordance with a first DRX configuration of the multiple DRX configurations;
receive a first indication to switch to a second DRX mode; and
operate in the second DRX mode in accordance with a second DRX configuration of the multiple DRX configurations.

23. The apparatus of claim 22, wherein the one or more processors are individually or collectively configured to cause the UE to:
receive a second indication to switch to the first DRX mode; and
operate in the first DRX mode.

24. The apparatus of claim 23, wherein one or more of the first indication or the second indication is included in downlink control information.

25. The apparatus of claim 22, wherein the one or more processors are individually or collectively configured to cause the UE to:
receive a DRX switch timer associated with a DRX switching configuration;
start the DRX switch timer at a start of the second DRX mode;
switch back to the first DRX upon expiration of the DRX switch timer; and
operate in the first DRX mode.
